(19) United States
(12) Patent Application Publication
(10) Pub. No.: US 2017/0270562 A1
(43) Pub. Date: Sep. 21, 2017

(54) COMBINING USER CONTENT WITH SUPPLEMENTAL CONTENT AT A DATA STORAGE DEVICE

(71) Applicant: WESTERN DIGITAL TECHNOLOGIES, INC., SAN JOSE, CA (US)

(72) Inventors: REFAEL BEN-RUBI, ROSH HAAYIN (IL); TAL HELLER, SUNNYVALE, CA (US)

(73) Assignee: WESTERN DIGITAL TECHNOLOGIES, INC.

(21) Appl. No.: 15/616,529

(22) Filed: Jun. 7, 2017

Related U.S. Application Data
(63) Continuation-in-part of application No. 13/054,536, filed on Jan. 17, 2011.
(60) Provisional application No. 61/312,031, filed on Mar. 9, 2010.

(51) Int. Cl. G06Q 30/02; G10L 15/22; G10L 15/08; G10L 25/51; G06F 7/02; G06F 17/30

(52) U.S. Cl. CPC G06Q 30/0251; G06F 7/026; G06F 17/30997; G10L 15/08; G10L 25/51; G10L 15/22; G10L 2015/088

(57) ABSTRACT

In a particular implementation, a data storage device includes a memory configured to store one or more user content items, a plurality of supplemental content items, and a first plurality of keywords associated with the plurality of supplemental content items. The data storage device further includes a controller coupled to the memory and configured to analyze content of a particular user content item of the one or more user content items to determine one or more descriptors related to the content, to select a particular supplemental content item of the plurality of supplemental content items based on the one or more descriptors and the first plurality of keywords, and to combine the particular supplemental content item with the particular user content item to generate an augmented content item.

### CROSS REFERENCE TO RELATED APPLICATIONS

The present application claims priority from and is a continuation-in-part of U.S. patent application Ser. No. 13/054,536, filed on Jan. 17, 2011, which claims the benefit of U.S. Provisional Patent Application No. 61/312,031, filed on Mar. 9, 2010. U.S. patent application Ser. No. 13/054,536 also claims priority to International Application No. PCT/IB2010/001220, filed May 21, 2010, which claims the benefit of U.S. Provisional Patent Application No. 61/312,031, filed on Mar. 9, 2010. The contents of each of these applications are incorporated by reference herein in their entirety.

### FIELD OF THE DISCLOSURE

The present disclosure is generally related to combining a user content item with a supplemental content item, such as an advertisement.

### BACKGROUND

Providers of goods and services continually seek new channels through which to advertise their products. Users of computers and personal electronics, such as media players, game devices, wireless telephones, and similar devices may be amenable to ways to defray the cost of using those devices or to reduce the cost of accessories for those devices.

Advertisers may distribute promotional materials for goods and services they seek to promote by providing data storage devices, such as memory cards or Universal Serial Bus flash drives, with promotional content stored on the data storage devices. Just as mass media programs or publications are provided for free or at a reduced cost to the public because they are subsidized by the advertisements included therein, the data storage devices may be subsidized by the advertisers and provided for free or at a reduced cost. Consumers may appreciate having the reduced cost or free data storage devices. However, even if the promotional content is stored on the data storage devices when they are distributed, the advertisers have no assurance that the users will access the promotional content or that the users will not erase the promotional content from the data storage device to free storage for user files.

### SUMMARY

Data storage devices and methods to combine advertisements or other supplemental content stored on a data storage device with user content items stored on the data storage device are disclosed. The data storage device stores supplemental content, such as an advertisement, separately from a user data area. After user content is stored to the data storage device, the data storage device augments the user content with supplemental content prior to display or playback of the user content. Selection and placement of the supplemental content may be determined according to rules (such as rules for selecting supplemental content that is compatible with the user content). Selection of supplemental content to combine with user content items may be determined based on one or more descriptors associated with the user content items and keywords associated with the supplemental content. This selection of supplemental content may result in augmented content items that are more relevant to a user and that enhance user experience as compared to other augmented content items.

### BRIEF DESCRIPTION OF THE DRAWINGS

FIG. 1 is a block diagram of a data storage device in communication with a host device in which the data storage device includes a second storage area in which supplemental content items are stored;

FIG. 2 is a block diagram of the data storage device of FIG. 1 in which a particular supplemental content item is matched to a user content item by metadata and a resulting augmented content item is presented via the host device;

FIGS. 3A-3E are diagrams illustrating supplemental image, text, audio, and video content items combined with user content items to generate augmented content items with supplemental content items in various positions relative to the user content items;

FIG. 4 is a data flow diagram showing an augmented content item being generated by combining a supplemental content item with a user content item in response to a request received via a host device to access the user content item;

FIG. 5 is a data flow diagram showing an augmented content item being generated by combining a supplemental content item with a user content item and stored in a data storage device in a third storage area;

FIG. 6 is a flow diagram of an embodiment of a method of combining an advertisement with a content file;

FIG. 7 is a flow diagram of an embodiment of a method to update supplemental content items stored in a data storage device;

FIG. 8 is a flow diagram of an embodiment of a method to receive one or more user content items and combine the user content items with supplemental content items to generate one or more augmented content items at a data storage device;

FIG. 9 is a block diagram of a first example of a system that is configured to combine user content items and supplemental content items;

FIG. 10 is a block diagram of a second example of a system that is configured to combine user content items and supplemental content items;

FIG. 11 is a data flow diagram showing an augmented content item being generated by combining a supplemental content item with a user content item; and

FIG. 12 is a flow diagram of an implementation of a method to combine a user content item and a supplemental content item.

### DETAILED DESCRIPTION

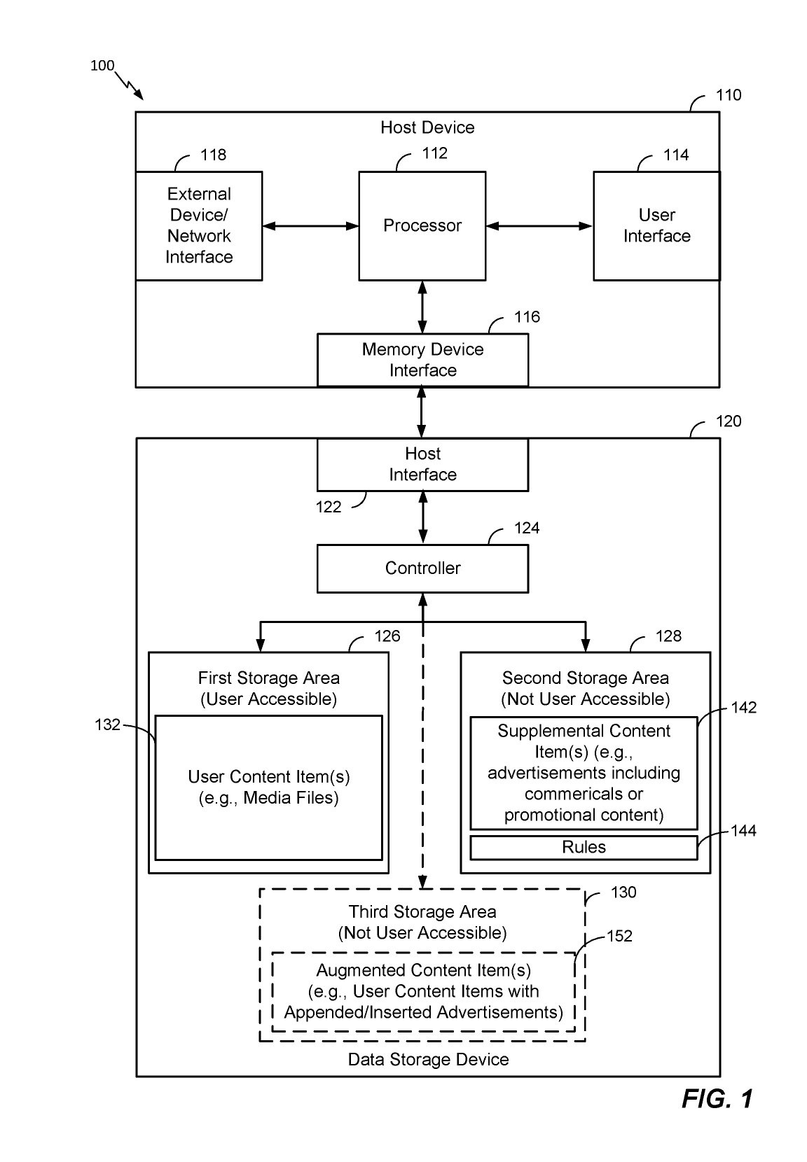

Referring to FIG. 1, a particular embodiment of a system to combine user content with supplemental content is depicted and generally designated 100. The system 100 includes a host device 110 operatively coupled to a data storage device 120. The data storage device 120 is configured to selectively combine one or more user content items 132 with one or more supplemental content items 142, such as advertisements, and to generate augmented content items 152 that include both a user content item and a supplemental content item. As a result, when a request is made to the data storage device 120 to retrieve the user content item 132, the data storage device 120 may return the augmented content item 152 that includes the requested user content combined with one or more advertisements or promotional items.

The host device 110 is illustrated as including a processor 112 that is coupled to a user interface 114, a memory device interface 116, and an external device or network interface 118. For example, the host device 110 may include a portable computer, a wireless telephone, a wireless network device, a media player, a game device, a digital camera, a tablet device, any other host device that is configured to operatively couple to a data storage device, or any combination thereof. The host device 110 is responsive to instructions and commands received via the user interface 114 and may enable storage of user content items to the data storage device 120 via the memory device interface 116. For example, the host device 110 may include a still camera, a video camera, a microphone, or other content generation device (not shown) to capture user content for storage at the data storage device 120. As another example, the host device 110 may be configured to receive user content via the external device/network interface 118, such as movie files, image files, audio files, other content files, or any combination thereof.

The host device 110 is further responsive to commands received via the user interface 114 to request content to be retrieved from storage at the data storage device 120. For example, the user interface 114 may receive a command from a user of the host device 110 to retrieve an image file previously stored at the data storage device 120. In response, the host device 110 may send a request for data access to the data storage device 120 for retrieval of the image file. As another example, the host device 110 may be configured to access a file system of the data storage device 120 to retrieve a listing of available files that can be accessed by the host device 110 and the listing of available files may be displayed or otherwise presented to the user. The user interface 114 may include a display, an audio speaker, or another device to enable presentation of media content retrieved from the data storage device 120.

The data storage device 120 includes a host interface 122 and a controller 124 coupled to the host interface 122. The controller 124 is coupled to a first storage area 126, a second storage area 128, and a third storage area 130. The first storage area 126 is accessible to a user of the host device 110 and stores one or more user content items 132, such as one or more media files. The second storage area 128 is not accessible to the user and stores one or more supplemental content items 142, such as advertisements, promotional items, or other content that an advertiser or other organization may desire to provide to a user of the data storage device 120. Firmware of the controller 124 may be modified to maintain the separate storage areas 126, 128, and 130, and to restrict user access to the second storage area 128. The first storage area 126, the second storage area 128, and the third storage area 130 each may be implemented in a non-volatile memory device or a volatile memory device.

The controller 124 is configured to receive one or more user content items from the host device 110 when the data storage device 120 is operationally coupled to the host device 110 via the host interface 122. The controller 124 is also configured to store the one or more user content items 132 in the first storage area 126. For example, when the data storage device is implemented in a non-volatile memory device, the data storage device 120 may be a memory card, such as a Secure Digital SD® card, a microSD® card, a miniSD™ card (trademarks of SD-3C LLC, Wilmington, Del.), a MultiMediaCard™ (MMC™) card (trademark of JEDEC Solid State Technology Association, Arlington, Va.), a CompactFlash® (CF®) card (trademark of SanDisk Corporation, Milpitas, Calif.), or a solid-state drive (SSD). In other implementations, the data storage device 120 may be an external removable storage device, such as a Universal Serial Bus (USB) flash drive (UFD). The data storage device 120 may be embedded within the host device 110 or may be configured to be removably coupleable to the host device 110 via the host interface 122. As another example, the data storage device 120 may be wirelessly coupled to the host device 110 via the host interface 122, such as via a wireless USB or ad-hoc piconet (e.g., Bluetooth®, trademark of Bluetooth SIG, Inc., Bellevue, Wash.).

The controller 124 is configured to combine a particular supplemental content item from among the one or more supplemental content items 142 with a particular user content item from among the one or more user content items 132 to generate an augmented content item 152. As used herein, a content item is “augmented” when both the original content of the item and supplemental content (e.g. advertisements) are provided during playback of the content item. In the embodiment illustrated in FIG. 1, the augmented content item 152 may be stored in the third storage area 130 that, like the second storage area 128, is not user accessible. The controller 124 may generate the augmented content item 152 independently of receiving any commands from the host device 110, and instead may generate the augmented content item 152 in response to a write operation being performed to the first storage area 126, a period of read and write inactivity at the data storage device 120, or in response to initiating a “garbage collection process” (e.g., a storage reclamation procedure to enable erasure of one or more sets of memory blocks from a first memory location by copying valid data from the sets of memory blocks). In an alternative embodiment, the data storage device 120 may not include the third storage area 130, and instead the controller 124 may be configured to generate the augmented content item 152 in response to a request from the host device 110 for access to the user content item 132. The controller 124 may be configured to generate the augmented content item 152 “on the fly” as the user content item 132 is retrieved from the first storage area 126 in response to the request from the host device 110.

By enabling the data storage device 120 to store user content items 132 and to modify the user content items 132 to include one or more advertisements or other supplemental content items 142 that may be provided by a supplier of the data storage device 120, the user may receive an operational storage device that may be used to freely store user content. A provider of the advertisements or other supplemental content items 142 may be able to designate advertisements or other supplemental content items 142 to be added to the user content items 132. To illustrate, the cost to make and distribute the data storage device 120 may be partially or wholly financed or offset by fees paid by an advertiser. The advertiser may benefit from usage of the data storage device 120 by the user due to presentation of advertisements, promotional content, or other supplemental content items 142 provided with the data storage device 120 that are presented with the user content items 132 upon retrieval of the user content items 132 from the data storage device 120. In addition, or alternatively, by having the data storage device 120 configured to generate the augmented content items 152 including the supplemental content items 142, such functionality may be performed without implementing hardware or software changes on the host device 110.

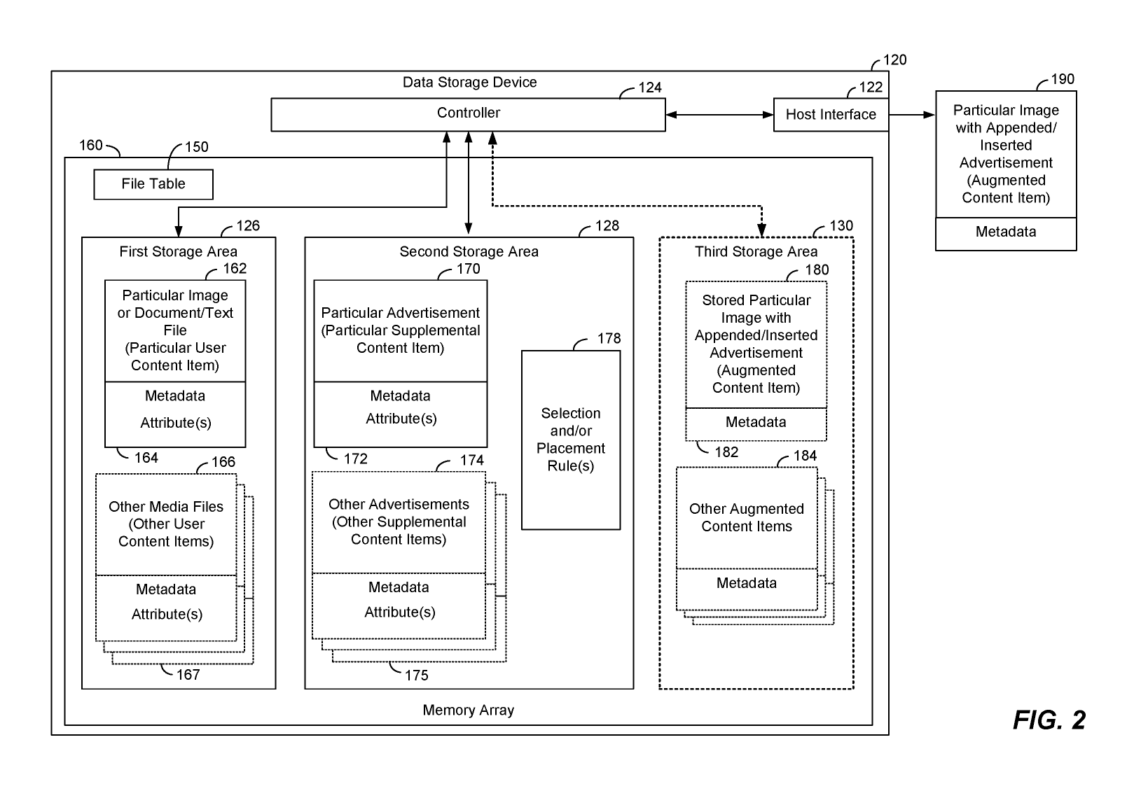

Referring to FIG. 2, a second embodiment of the data storage device 120 of FIG. 1 is depicted. The data storage device 120 includes the host interface 122 coupled to the controller 124. The first storage area 126 and the second storage area 128 are inside a memory array 160, such as a flash memory array, that is coupled to the controller 124. The third storage area 130 is also inside the memory array 160. The memory array 160 also includes a file table 150, such as a file allocation table (FAT) or other file directory that identifies locations in the data storage device 120 from which the user content items 132 may be accessed.

The first storage area 126 stores a particular user content item (also referred to herein as a particular image as a representative example) 162 that has associated metadata 164, such as one or more attributes of the particular user content item 162. The first storage area 126 also includes a plurality of other user content items (also referred to herein as other media files as a representative example) 166. One or more of the other media files 166 may be associated with corresponding metadata 167, such as one or more attributes of the other media files 166. The first storage area 126 may be implemented, for example, as a public partition of the memory array 160 that is accessible to any user of the data storage device 120.

The second storage area 128 includes a particular supplemental content item (also referred to herein as a particular advertisement as a representative example) 170, that has associated metadata 172 including one or more attributes associated with the particular supplemental content item 170. The second storage area 128 also includes a plurality of other supplemental content items (also referred to herein as one or more other advertisement as a representative example) 174 with associated metadata 175, such as one or more attributes of the other supplemental content items 174. The second storage area 128 further stores selection and/or placement rules 178. The selection and/or placement rules 178 may be accessed by the controller 124 to control selection of the particular advertisement 170 from the plurality of other supplemental items 174 and for placement of the particular advertisement 170 within the particular user content item 162.

The second storage area 128 may have restricted access. For example, the second storage area 128 may be accessible to the provider of the supplemental content, such as an advertiser or other promoter, but not to an end user of the data storage device 120. The storage device 120 may be configured to receive an advertisement command from an external device via the host interface 122. The advertisement command may indicate an authentication of the provider of the supplemental content for storage within the second storage area 128. The controller 124 may further be configured to receive the selection and/or placement rules 178 via an advertisement command. The advertisement command may bear indicia that the command is presented by a provider of selection and/or placement rules that is authorized to update the rules 178 within the second storage area 128.

The third storage area 130 is illustrated inside the memory array 160. The third storage area 130 includes a particular augmented content item (also referred to herein as a stored particular image as a representative example) 180, such as the stored particular image 162 that has been combined with the particular advertisement 170 as a stored particular image 180 with associated metadata 182. One or more other augmented content items 184 are also illustrated as stored within the third storage area 130. The third storage area 130 may be restricted to prevent a user from storing content in the third storage area 130. As such, the controller 124 may be configured to read user data from the first storage area 126, combine the retrieved user data with supplemental data from the second storage area 128 to generate augmented content items, and write the augmented content items 180 and 184 to the third storage area 130 to be retrievable upon a request for access to the user data item. Although the data storage device 120 is illustrated as including the third storage area 130, in other embodiments the memory array 160 may not include the third storage area 130 and instead the data storage device 120 may generate augmented content items “on the fly” as the user content is retrieved in response to requests for access by a host device.

The controller 124 may be configured to add an indicator to the metadata of the augmented content items (e.g. the metadata 182) to indicate that the content item has been augmented with non-user content, such as a “contain ADS” indicator. Alternatively, the controller 124 may add an indicator or mark at a predefined location within a user data area of the augmented content item. Although the mark may alter the user data, such as by overwriting a particular value or pattern within the user data, the mark may be small enough to be undetectable by a human auditory system (during playback of audio content) or by a human visual system (during playback of image or video content). The controller 124 may be configured to check metadata and/or the particular location of received media files for the “contain ADS” indicator to ensure that additional advertisements are not added to an already-augmented file. For example, when an augmented media file is read from the data storage device 120 and written again to the data storage device 120, the controller 124 may detect the “contain ADS” indicator and not add additional supplemental content items to the file.

The controller 124 may be configured to access one or more of the selection and/or placement rules 178 to determine a selection and/or placement of one of the supplemental content items 170 and 174 within the particular user content item 162. For example, the selection and/or placement rules 178 may include one or more rules that direct at least one of a choice of the particular supplemental content item 170 and placement of the particular advertisement 170 relative to a particular user content item 162 in the augmented content item 180. For example, the selection and/or placement rules 178 may determine placement of the particular advertisement 170 relative to the particular image 162 within the augmented content item (also referred to herein as the particular image with appended or inserted advertisement as an example) 190.

For the particular user content item 162 and the other user content items 166, the metadata 164 and 167, respectively, may indicate one or more attributes of the particular user content item 162 or the other user content items 166. For example, the metadata 164 may indicate that the particular user content item 162 has a particular media type, such as a static type (e.g., an image type or a document/text type). The controller 124 may be configured to access the selection and/or placement rules 178 to determine that an appropriate advertisement to be added to the particular image 162 would be an advertisement having a similar media type. The controller 124 may be configured to locate the particular advertisement 170 from among the advertising content stored in the second storage area 128 for selection to be used to augment the particular image 162.

The particular supplemental content item 170 may of the same media type as the particular user content item 162 or of a compatible media type. For example, the media type may include one or more of a static type, such as an image type or a document/text type, and a dynamic type, such as an audio type or a video type. To illustrate, an image type may include Joint Photographic Expert Group (JPEG) image file format data, while an audio type may include a Motion Picture Expert Group (MPEG) Audio Layer 3 (MP3) format data and a video type may include a Motion Picture Expert Group (MPEG) 4 (MP4) format data.

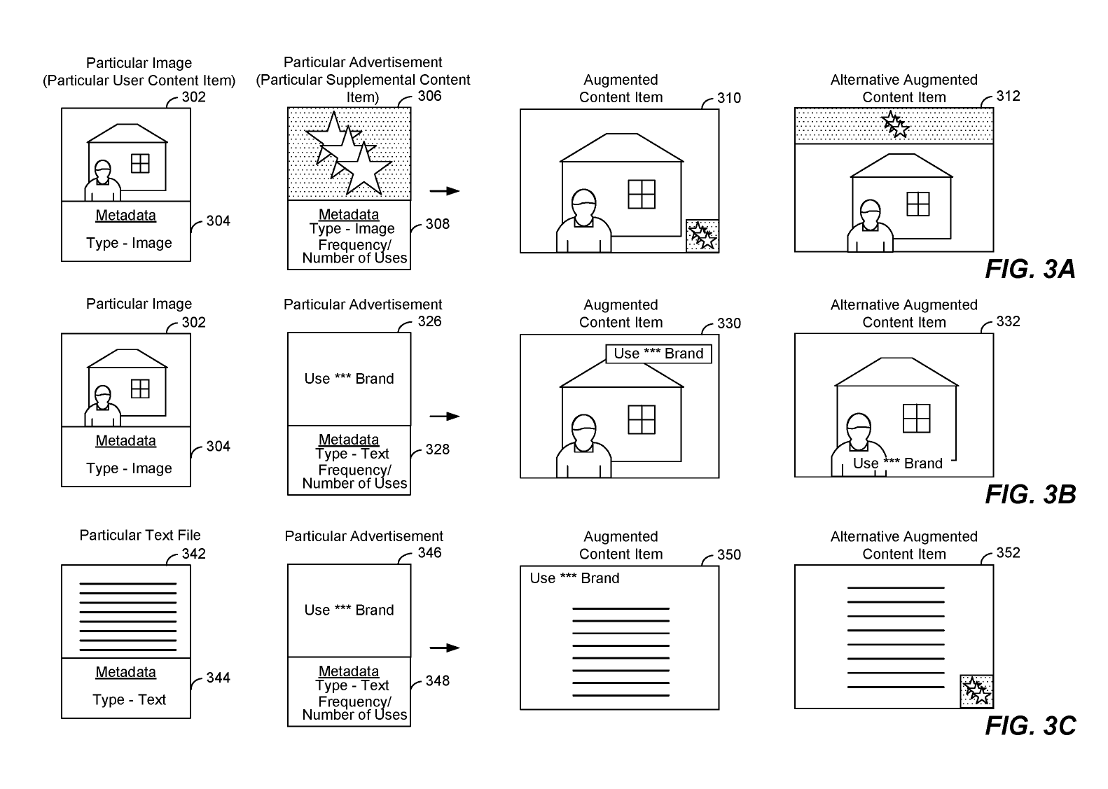

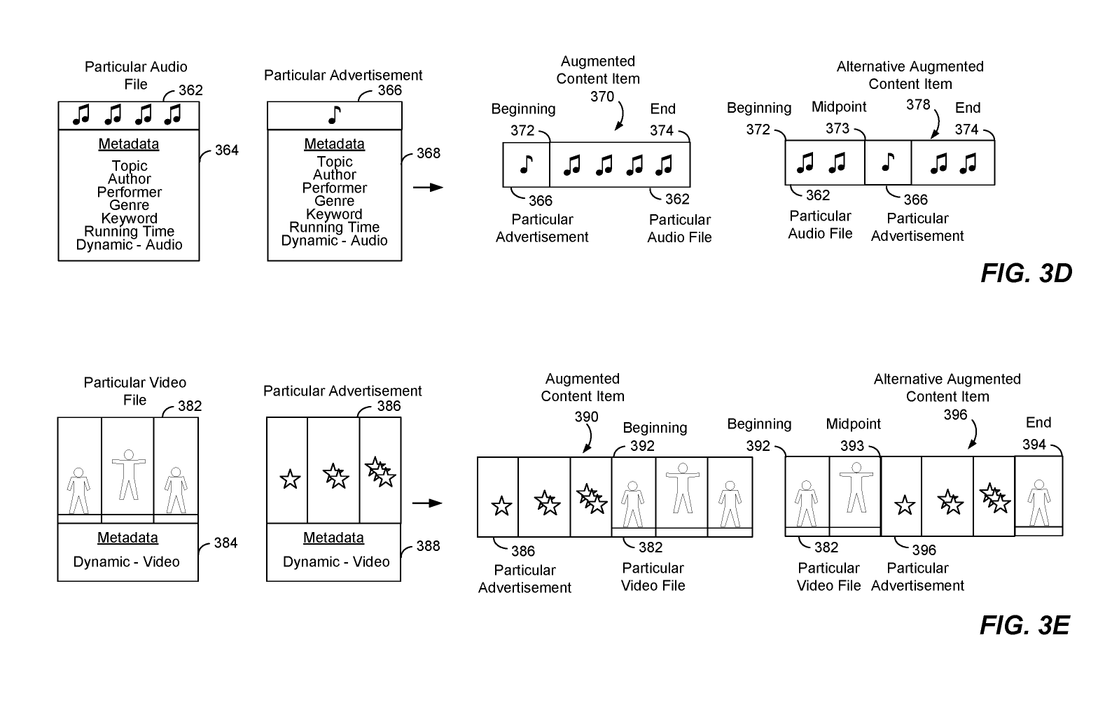

When the particular user content item 162 is of the image type or the document or text type, the particular supplemental content item 170 may also be of the image type or of the text type and the augmented content item 190 may include the particular supplemental content item 170 superimposed over a specified portion of the particular user content item 162. For example, the particular supplemental content 172 may be positioned in a specified corner or along a specified edge of a user image, as is illustrated in FIG. 3A, FIG. 3B, and FIG. 3C. The selection and placement rules 178 may limit selection of the particular supplemental content item 170, for example, to a supplemental content item that has a size that is not more than ten percent of the size of the particular user content item 162. Alternatively, the selection and placement rules 178 may direct the controller 124 to scale a size of the particular supplemental content item 170 so that the particular supplemental content item 170 spans not more than ten percent of the particular user content item 162 when the particular supplemental content item 170 is combined with the particular user content item 162.

As another example, when the particular user content item 162 is of the dynamic type (e.g., an audio type or a video type), the particular supplemental content item 170 may be of a same dynamic type and the augmented content item 190 includes the particular supplemental content item 170 either appended to a beginning of the particular user content item 162 or inserted within the user content audio or video file between a beginning and an end of the particular user content item 162, as is illustrated in FIG. 3D and FIG. 3E. As another example, the particular supplemental content item 170 may have a running time that is not more than a specified portion of a running time of the particular user content item 162. For example, when the particular user content item 162 is an audio file, the metadata 164 may indicate that a running time of the audio file is three minutes. The particular supplemental content item 170, such as an audio commercial to be included in the augmented content item 190, may be constrained to a duration that does not exceed a specified commercial duration or a specified portion of the running time of the particular user content item 162. To illustrate, the particular supplemental content item 170 may be limited to a duration of not more than ten seconds or of not more than two percent of the three minute running time, as illustrative, non-limiting examples.

The controller 124 may be responsive to the selection and/or placement rules 178 to choose the particular supplemental content item 170 from the plurality of supplemental content items 174 based on matching one or more attributes of the metadata 172 associated with the particular supplemental content item 170 with one or more attributes of the metadata 164 associated with the particular user content item 162. For example, the metadata 164 of the particular user content item 162 and the metadata 172 of the particular advertisement 170 may include attributes such as a topic, an author, a performer, a genre, or a keyword. When the particular user content item 162 is an audio file and an attribute of the metadata 164 of the particular user content item 162 identifies the performer, the particular supplemental content item 170 that is selected may be selected based on an attribute of the metadata 172 listing the same performer. Similarly, the selection of the particular supplemental content item 170 may be based on matching an attribute of the metadata 164 of the particular user content item 162 that identifies the genre of the audio file or some other attribute.

The selection and/or placement rules 178 may specify criteria regarding a number of times each of the plurality of supplemental content items 174 is used to augment user content within the storage device 120, or a frequency with which each of the plurality of supplemental content items 174 is used to augment user content in relation to others of the plurality of supplemental content items 174. To illustrate, a provider of the data storage device 120 may enable advertisers to provide advertisements and to specify a number of usages of the advertisements within augmented user content. After a specified number of insertions of each advertisement within retrieved user data, a particular advertisement may no longer be selected for insertion into user content to generate augmented content. As another example, a frequency of insertion of one or more particular advertisements may be specified. As another example, an order of use or tracking data indicating a most recently used and least recently used status of one or more of the plurality of supplemental content items 174 may be maintained such that subsequent retrievals of the user content may include a variety of the supplemental content items 174. In this manner, the augmented content item 190 appears “fresh” or “live” as opposed to fixed or repetitive. Alternatively, or in addition, the number or frequency of uses of a particular advertisement may be specified by a rule based on a fee or other consideration provided by the advertiser.

The controller 124 may be configured to maintain the second storage area 128 as a hidden area. For example, the second storage area 128 may be maintained as a hidden partition that is accessible only to authenticated users having authority to access the second storage area 128. For example, the second storage area 128 may be maintained as a TrustedFlash™ hidden partition within the memory array 160. At least a portion of content of the second storage area 128 may be updated via the host interface 122. For example, the content of the second storage area 128 may be updated via a host command received by the host interface 122. The host command to update the content of the second storage area 128 may include authentication information to distinguish the originator of the command from the end-user of the device. For example, access to update data in the second storage area 128 may be restricted to advertisement providers and service providers that may send updated data to the data storage device 120 via the host device 110 from a remote network device (not shown in FIG. 2). Conversely, access to the first storage area 126 may be open to any user of the data storage device 120.

The controller 124 may be configured to access and maintain the file table 150 to effectuate locating the particular user content item 162, locating insertion points into which the particular supplemental content item 170 may be added or appended, and to locate the augmented content item 180 after storage of the augmented content item 180 to the third storage area 130. For example, the file table 150 may be a file allocation table (FAT) that is accessible to or maintained by the controller 124.

The controller 124 may be configured to access the file table 150, which may include a FAT table and one or more directory entries in a FAT file system or FAT32 file system implementation. For example, after selecting the particular advertisement 170 to be inserted into or appended to the particular user content item 162, the controller 124 may locate portions of the particular user content item 162 that may be stored throughout the memory array 160 as indicated by the FAT table. The controller 124 may locate a specific insertion point within the particular user content item 162 based on a location within one or more consecutive regions of data corresponding to the selected user content item 162. For example, a region of data may correspond to a cluster, a logical block address (LBA), a block, a page, a sector, or other unit. The controller 124 may append, overwrite, or otherwise redirect pointers within the file system to insert the particular supplemental content of the particular supplemental content item 170 to generate the augmented content item 190.

After generation of the augmented content item 190, the controller 124 may be configured to update the file table 150. For example, the controller 124 may update the file table 150 by modifying a directory entry corresponding to the particular user content item 162 to point to a file location associated with the particular augmented content item 180 stored within the third storage area 130. The file table 150 may be used when the host device 110 requests access to the particular user content item 162. As another example, the controller 124 may update the file table 150 to indicate one or more clusters within a chain of clusters within a cluster allocation table of a FAT system.

The first storage area 126 and the second storage area 128 may each be in a separate partition within a single memory array within the data storage device 120. Alternatively, the first storage area 126 and the second storage area 128 may be located in separate memory arrays within the data storage device 120. If the third data storage area 130 is used, the third data storage area 130 may be in a separate memory array in the data storage device 120. Alternatively, the third data storage area 130 may be in a separate partition in a same memory array that includes the first data storage area 126, the second data storage area 128, or both the first data storage area 126 and the second data storage area 128.

Referring to FIGS. 3A-3E, embodiments of creation of augmented content items using particular user content items and particular supplemental content items are depicted for a variety of media types. FIG. 3A depicts a particular user content item (also referred to herein as a particular image, as an example) 302 with associated metadata 304 identifying a media type of the particular user content item 302 as an image type. A particular supplemental content item 306 is a particular advertisement having metadata 308 indicating that the particular advertisement 306 is appropriate for inclusion within or augmentation to file types of the image type or, possibly, another static type, such as a text type. The metadata 308 also includes data corresponding to a frequency of use or number of uses of the particular advertisement 306. FIG. 3A further shows a simplified illustration of overlaying the particular advertisement 306 within the particular image 302 to generate an augmented content item 310.

To illustrate, one or more blocks of a JPEG file may be identified by the controller 124 of FIG. 1, and data corresponding to the identified blocks corresponding to a lower right hand corner of the particular image 302 may be deleted and replaced with data corresponding to the particular advertisement 306. In a particular illustrative embodiment, the controller 124 only modifies blocks of the JPEG file of the particular image 302 that are to be replaced as part of combining the particular advertisement 306 with the particular image 302. For example, if the particular image 302 includes a bitmap (BMP) file, the controller 124 may only modify lines of the particular image 302 that are to be replaced as part of combining the particular advertisement 306 with the particular image 302. As another example, rather than deleting the original content and replacing it with the particular advertisement content, the particular advertisement 306 may be overlaid, such as in a meshing or merging operation. In either case, when the augmented content item 310 is presented to a host device as a particular image with an appended or inserted advertisement 190 (FIG. 2) or is stored in a third storage area 130 (FIG. 2), the augmented content item 310 is presented or stored as a same media type as the particular user content 302 (i.e., in the example of FIG. 3A, as a JPEG image file).

An alternate augmented content item 312 is also illustrated showing the particular advertisement 306 appended as a banner advertisement in an upper portion of the particular image 302. To illustrate, the particular advertisement 306 may be appended to the particular image 302, increasing the total size of the alternative augmented content item 312 to be larger than the particular image 302, while preserving an aspect ratio of the particular image 302. In another example, an aspect ratio of the particular image 302 may be adjusted so that the alternative augmented content item 312 maintains an original dimension of the image. To illustrate, the controller 124 may shrink or crop the particular image 302 to adhere to a size constraint.

A supplemental content item and the particular user content item may have different specific types but may be otherwise compatible. For example, if both the particular user content item and the supplemental content item are of static media types, such as images or text files, the particular user content item may be combined with the supplemental content item even though the specific media types (e.g., image as opposed to text) are different.

FIG. 3B illustrates the particular image 302 with the associated metadata 304 identifying a media type of the particular image 302 as an image type. A particular advertisement having metadata 328 indicating that the particular advertisement 326 is of a text type. The text type of the particular advertisement 326 may be appropriate for inclusion within or augmentation to user content of the text type or another static type, such as an image type. The metadata 328 also includes data corresponding to a frequency of use or number of uses of the particular advertisement 326. FIG. 3B further shows a simplified illustration of overlaying the particular advertisement 326 within the particular image 302 to generate an augmented content item 330. To illustrate, one or more blocks of a JPEG file may be identified by the controller 124 of FIG. 1, and data corresponding to the identified blocks corresponding to a portion of the particular image 302 toward an upper right hand corner of the particular image 302 may be deleted and replaced with data corresponding to the particular advertisement 326. As another example, in an alternative augmented content item 332, the particular advertisement 326 may be overlaid over a portion of the original image 302, such as in a meshing or merging operation.

FIG. 3C depicts the particular user content item as a particular text file 342 with the associated metadata 344 identifying a media type of the particular user content item as a text type. A particular supplemental content item 346 is a particular advertisement having metadata 348 indicating that the particular advertisement 346 is of a text type that is appropriate for inclusion within or augmentation to user content of the text type. The metadata 348 also includes data corresponding to a frequency of use or number of uses of the particular advertisement 346. FIG. 3C further shows a simplified illustration of overlaying the particular advertisement 346 within the particular text file 342 to generate an augmented content item 350. To illustrate, a portion of the text file 342, such as one or specified lines or other positions in a text file, may be identified by the controller 124 of FIG. 1, and data corresponding to the particular advertisement 346 may be inserted within the particular text file 342. As another example, in an alternative augmented content item 352, a particular advertisement of an image type may be inserted at a specified location in the particular text file 342. The supplemental content item 346 may be included in a header, a footer, or a margin of the particular text file 342, or superimposed as a watermark within the particular text file 342.

FIG. 3D illustrates an example of a particular audio file 362 having metadata 364. The metadata 364 may include information descriptive of the particular audio file 362, such as a topic, an author, a performer, a genre, a keyword, a running time, or a media type. The media type may be a dynamic media type illustrated as an audio type. The particular audio file 362 may be combined with a particular advertisement 366 having associated metadata 368 which may include a topic, author, performer, genre, keyword, running time, and media type (e.g., a dynamic type, such as the audio type). An example of an augmented content item 370 includes the particular advertisement 366 inserted before a beginning portion 372 of the particular audio file 362.

For example, the controller 124 may decode at least a portion of the particular audio file 362, traverse the particular audio file 362, and update indices that are used to playback the particular audio file 362 to append or insert the particular advertisement 366. The controller 124 parses a sync word that identifies a start of a frame in the particular audio file 362 and parses a bit rate to combine the particular advertisement 366 with the audio file 362 in a way that enables the augmented content item 370 including the particular advertisement 366 to be recognizable by a playback device. When the augmented content item 370 is presented to a host device or is stored in a third storage area 130 (FIG. 2), the augmented content item 370 is presented or stored as a same media type as the particular audio file 362 (e.g., as an MP3 file).

To illustrate, the beginning 372 and an end 374 of audio content of the particular audio file 362 may be identified by the controller of the data storage device, and the particular advertisement 366 may be appended prior to the beginning 372. In an embodiment where the augmented content item 370 is stored within the data storage device, the augmented content item 370 may be stored as a single audio file. In another embodiment where the augmented content item 370 is generated “on the fly” as the request for a particular audio file 362 is carried out, the particular advertisement 366 may be provided followed by the particular audio file 362, with run time tracking and other audio content metrics updated such that the audio presented to the host device appears to be a single audio file, without storing the particular audio file 362 and the particular advertisement 366 as a single audio file.

An alternative augmented content item 378 is also illustrated where the particular audio file 362 has the particular advertisement 366 inserted at a midpoint 373 between the beginning 372 and the end 374. Although illustrated as being inserted at the midpoint 373, it will be understood that the insertion of the particular advertisement 366 may appear at any location within the particular audio file 362. The placement rules 178 (FIG. 2) may identify a point in the particular audio file 362 at which the particular advertisement 366 is inserted. The placement rules 178 may specify a fixed location relative to the particular audio file 362 for insertion of the particular advertisement 366, such as at the beginning 372 of the particular audio file 362 or at a point a specified number of minutes or seconds from the beginning 372 of the particular audio file 362.

Alternatively, the placement rules 178 may specify a relative location in the particular audio file 362 at which the particular advertisement 366 is inserted depending on the running time of the particular audio file 362. For example, the placement rules 178 may specify that the particular advertisement 366 be inserted halfway through the particular audio file 362, thirty percent of the way through the particular audio file 362, or at another point relative to the length of the particular audio file 362. The placement rules 178 also may specify the placement of the particular advertisement 366 based on a length of the particular advertisement 366 and the length of the particular audio file 362 so that, for example, an end of the particular advertisement 366 does not extend past the halfway point of the augmented content item 378.

FIG. 3E depicts a particular video file 382 of user content including metadata 384 indicating a media type of the particular video file 382 as a dynamic media type (i.e., the video type). A particular advertisement 386 includes metadata 388 indicating the dynamic video media type. An augmented content item 390 is illustrated as having the particular advertisement 386 preceding the particular video file 382. For example, a beginning 392 of video content of the particular video file 382 may be located, and the particular advertisement 386 may be appended prior to the beginning 392. An alternative augmented content item 396 is illustrated where the particular advertisement 386 is inserted within the particular video file 382 at a midpoint 393 that is between the beginning 392 and end 394 of video content the particular video file 382.

To insert the particular advertisement 386 into the particular video file 382, a controller, such as the controller 124, may decode at least a portion of the particular video file 382, traverse the particular video file 382, and update indices that are used to playback the particular video file 382 to append or insert the particular advertisement 386. The controller 124 may parse a sync word that identifies a start of a frame in the particular video file 382 and a bit rate to combine the particular advertisement 386 in a way that enables the augmented content item 390 including the particular advertisement 386 to be recognizable by a playback device. When the augmented content item 390 is presented to a host device or is stored in a third storage area 130 (FIG. 2), the augmented content item 390 is presented or stored as a same media type as the particular video file 382 (e.g., as an MP4 file).

As described with reference to the augmented content item 390, the placement rules 178 (FIG. 2) may specify a point in the particular video file 382 at which the particular advertisement 386 is inserted. The placement rules 178 may specify a fixed location relative to the particular video file 382 for insertion of the particular advertisement 386, such as at the beginning 392 of the particular video file 382 or at a point a specified number of minutes or seconds from the beginning 392 of the particular video file 382. Alternatively, the placement rules 178 may specify a relative location in the particular video file 382 at which the particular advertisement 386 is inserted depending on the running time of the particular video file 382. For example, the placement rules may specify that the particular advertisement 386 be inserted halfway through the particular video file 382, ten percent of the way through the particular video file 382, or at another point relative to the length of the particular video file 382. The placement rules 178 also may specify the placement of the particular advertisement 386 based on a length of the particular advertisement 386 and the length of the particular video file 382 so that, for example, an end of the particular advertisement 386 does not extend past the halfway point of the running time of the augmented content item 390.

FIGS. 3D and 3E schematically illustrate insertion points to illustrate how the user data may be augmented with supplemental content for clarity of explanation and not of limitation. Insertion of the particular advertisement within a particular file type may include decoding the particular file type, performing one or more transformations to retrieve original data or decoded data, replacement of the decoded data with advertisement data, re-encoding of the modified user data including the advertisement data, and re-storing as the augmented content data. Such operations may be performed at a controller of the data storage device in accordance with one or more rules, such as by the controller 124 at the data storage device 120 in accordance with the selection and/or placement rules 178.

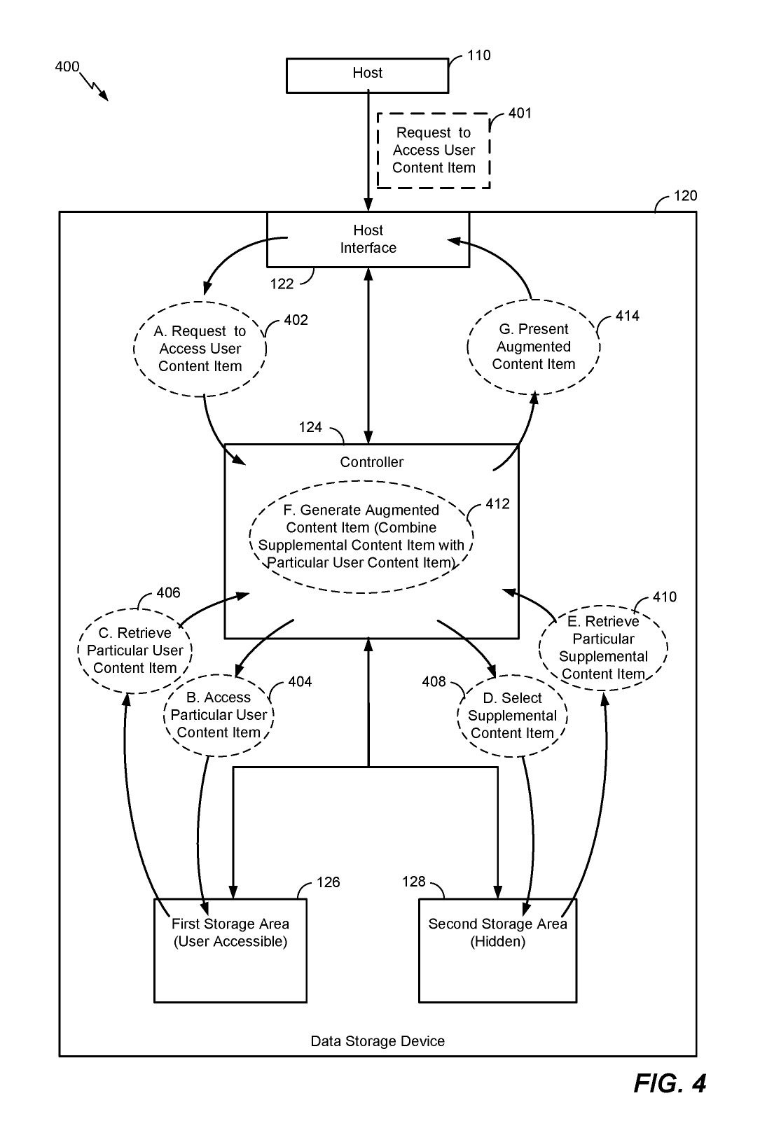

FIG. 4 illustrates a particular embodiment of a data flow diagram of operations within the data storage device 120, where an augmented content item is generated “on the fly” in response to a request 401 to access user content items from the host 110 sent to the data storage device 120. The request 401 is received at the host interface 122 and may be provided to the controller 124, at 402. The controller 124 may initiate access to a particular user content item, at 404. The access may be initiated at the first storage area 126, and the particular user content item may be retrieved from the first storage area 126, at 406. After retrieving the particular content user item, at 406, the controller 124 may access the second storage area 128 to select supplemental content item, at 408. The selected particular supplemental content item may be retrieved by the controller 124, at 410. The controller 124 may generate an augmented content item, such as by combining the particular supplemental content item with the particular user content item, at 412, and may present the augmented content item at the host interface 122, at 414. For example, presenting the augmented content item may include providing the augmented content item to the host device 110 when the host device 110 has been operatively coupled to the data storage device 120 via the host interface 122.

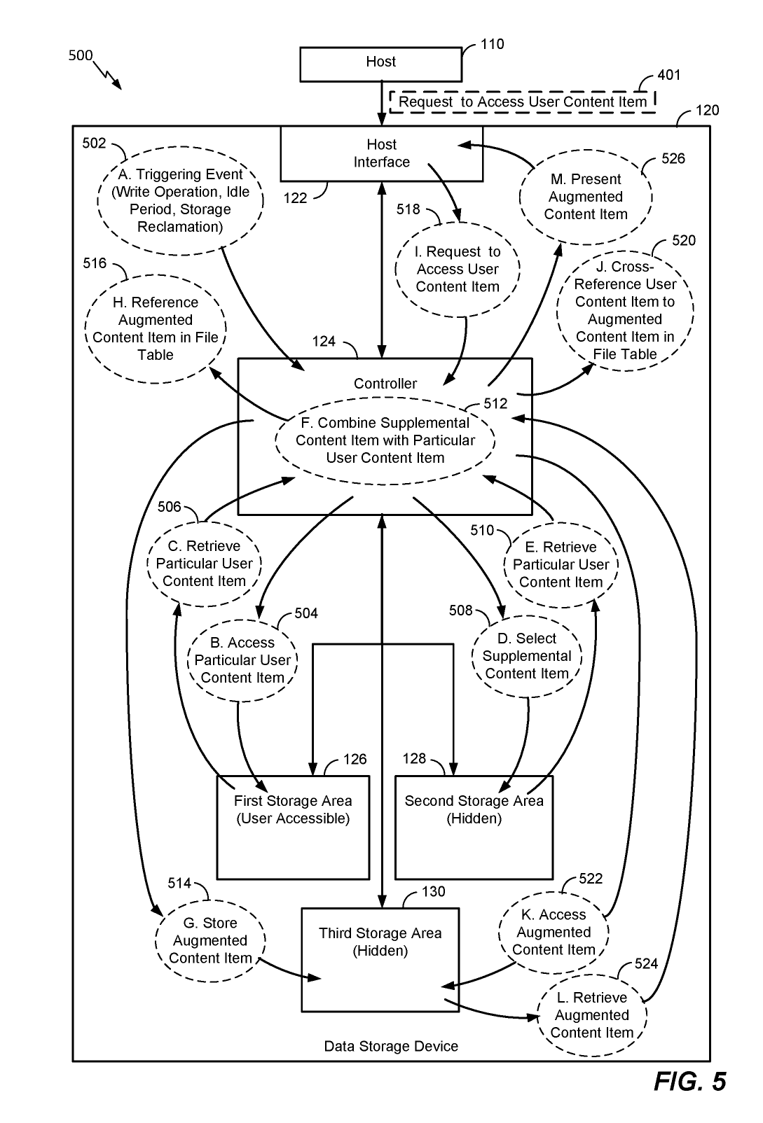

FIG. 5 depicts a particular embodiment of a data flow diagram of operations of the data storage device 120, where an augmented content item is generated independently of the request 401 from the host 110. A triggering event may be detected, at 502, by the controller 124. For example, the triggering event may include a write operation occurring at the first storage area 126, such as an addition of user content to the data storage device 120. Another example of a triggering event may be an idle period resulting from no read operations or write operations being performed at the data storage device 120 (e.g., read and write inactivity). As another example, the triggering event may be associated with commencement of or operation of a storage reclamation procedure (e.g., a “garbage collection”) at the data storage device 120 into which the first storage area 126 is incorporated. In response to the triggering event, the controller 124 may initiate access to the first storage area 126 to access a particular user content item, at 504. The controller 124 may retrieve the particular user content item, at 506. After retrieving the particular user content item, the controller 124 may initiate selection of a supplemental content item, at 508. The supplemental content item may be stored at the second storage area 128. The controller 124 may retrieve the supplemental content item from the second storage area 128, at 510. The controller 124 may combine the supplemental content item with the particular user content item, at 512, to create an augmented content item that may be stored to the third storage area 130, at 514.

After storing the augmented content item to the third storage area, the data storage device 120, in response to the request to access the user content item sent from the host, a request to access the user content item is processed at 518. The controller 124 may access a file table, such as the file table 150 of FIG. 2, and may cross-reference the user content item to the augmented content item stored in the third storage area 130, at 520. Having cross-referenced the user content item to locate the augmented content item at the third storage area 130, the controller 124 may access the augmented content item, at 522, and retrieve the accessed augmented content item, at 524. The accessed augmented content item may be provided by the controller 124 to the host interface 122 to present the augmented content item at the host interface 122, at 526, and the augmented content item may be retrieved by the host 110.

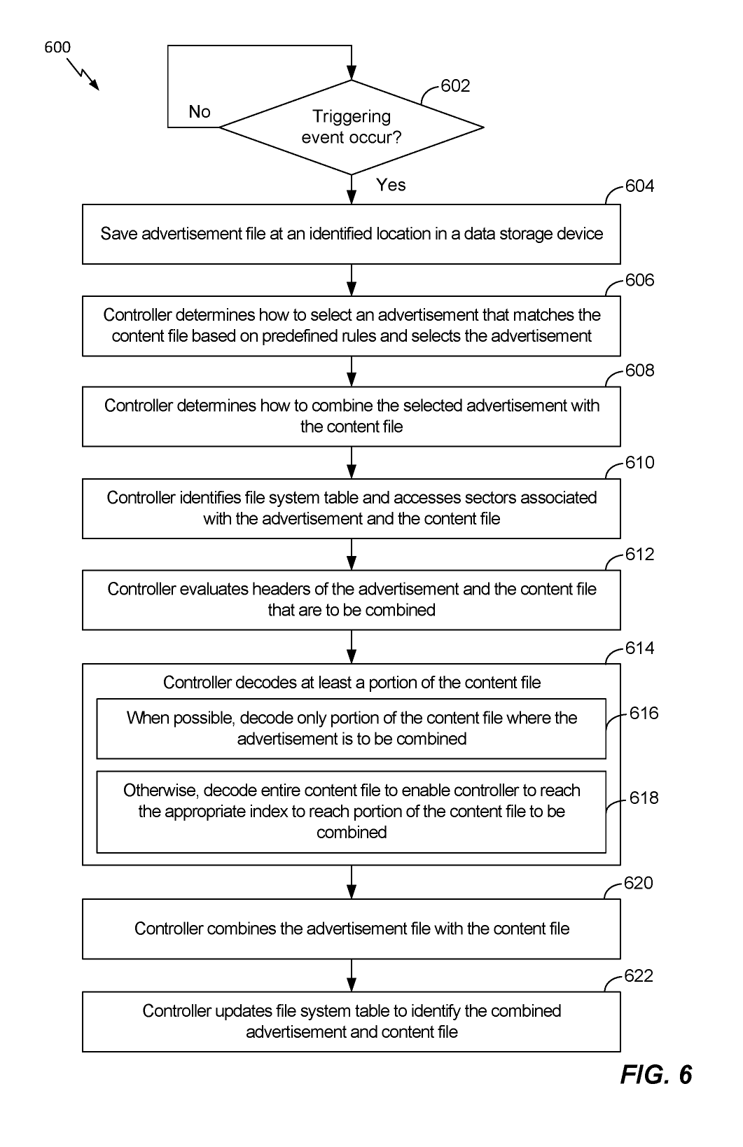

FIG. 6 illustrates a flow chart of a specific embodiment of a method 600 of combining an advertisement with a content file. The method 600 includes determining whether a triggering event has occurred, at 602. Referring to FIG. 1, the controller 124 may determine whether a triggering event has occurred, such as by detecting a period of read and write inactivity at the data storage device 120, or detecting initiation of a “garbage collection process” (e.g., a storage reclamation procedure to enable erasing one or more sets of memory blocks from a first memory location by copying valid data from the sets of memory blocks). The method 600 continues, at 602, until a triggering event occurs. When the triggering event is detected, at 602, an application may be run at a controller of a data storage device to combine an advertisement with a content file. The advertisement may be saved at an identified location in the data storage device, such as in a hidden partition, at 604. The content file may be saved in a dedicated area for received user content. For example, the content file may be stored at the first storage area 126 of FIG. 1 and the advertisement may be stored at the second storage area 128.

A controller determines how to select an advertisement that matches the content file based on one or more predefined rules and selects the advertisement, at 606. For example, the controller 124 accesses the selection and/or placement rules 178 (FIG. 2) that may be stored in the controller 124, in the second storage area 128, or in another portion of the data storage device 120. The selection criteria also may be provided by information associated with the advertisements or other supplemental content items when an advertisement command pushes new or additional advertisements to the data storage device 120. The controller 124 reads one or more selection rules from the selection and placement rules 178 or from advertisement headers or metadata to determine how to match an advertisement with a content file. The controller 124 accesses the second storage area 128 or other portion of the data storage device 120 where the advertisements are stored to select an advertisement. Referring to FIG. 2, the controller 124 may access headers or metadata of the supplemental content items 170 and 174 to find advertisements that are within the size or duration thresholds to be used with the content file. The controller 124 also may compare attributes of the metadata 164 for the content file (e.g., the particular image 162) with attributes of the metadata 172 and 175.

The controller determines how to combine the selected advertisement with the content file, at 608. For example, the controller 124 may access the selection and placement rules 178 or rules provided with an advertisement command to determine the location of the advertisement relative to the content file. For example, when the content file is an image file, the rules may direct the controller to insert the advertisement in a particular corner or along a particular edge of the content file. For an audio or a video file, the rules may direct the controller to append the advertisement to the beginning of the content file or to insert the advertisement at the midpoint or at another point of the content file.

The controller identifies a file system table and tracks sectors associated with the advertisement and the content file, at 610. Referring to FIG. 2, the controller 124 may include firmware that enables the controller 124 to maintain or to access a file table 150 to identify sectors or blocks of memory that are associated with advertisement files and content files.

The controller evaluates headers of the advertisement and the content file that are to be combined or merged, at 612. Based on the header information, the controller determines what portions of the content file, if any, are to be decoded to combine the files.

For example, no decoding may be necessary for a JPEG or BMP image file and the controller may locate a particular index in the content file to replace the content at the located index with advertisement content. Otherwise, the controller may decode at least a portion of the content file, at 614. When possible, the controller decodes only the portion of the content file, as determined at 612, that is to be decoded to combine the files, at 616. Alternatively, when it is not possible to decode only a portion of the content file, the entire content file is decoded to enable the controller to access the appropriate index and to access the portion of the content file at which the advertisement is to be combined or inserted, at 618.

The controller combines the advertisement with the content file, at 620. For example, when the image content file is in a JPEG format, the controller 124 may delete the blocks at the location where the advertisement is to be inserted and replace the deleted blocks with the advertisement. When the image content file is in a BMP format, the controller 124 may determine the lines of the content file that are to be modified and replace those lines with the advertisement. When the content file includes an audio or video content file, rules may determine whether the controller 124 appends the advertisement to a beginning of an audio or video content file or whether the controller inserts the advertisement at a midpoint of the audio or video content file. For example, when the content file is an MP3 audio file or an MP4 video file, the controller 124 may decode at least a portion of the content file, traverse the content file, and update indices that are used to playback the content file to append or insert the advertisement. The controller 124 may parse a sync word that identifies a start of a frame in the content file and a bit rate of the content file to combine the advertisement in a way that enables the resulting combined file to be recognizable by the host device 110.

The controller updates the file system table to identify the combined advertisement and content file, at 622. For example, the controller 124 may store the combined file in the third storage area 130 of the data storage device from which the combined file may be later retrieved when a request is received via the host interface 122 to access the content file. The controller 124 may update the file table 150 so that the file system maintains the address of the combined file and so that the content file identifier cross-references the combined file to the content file.

Alternatively, instead of storing the combined file, the controller 124 may combine the image content file and the advertisement “on the fly” and present combined files to the host device 110 without storing the combined file. When the combined file includes audio or video media, for example, the advertisement may be provided followed by the content file with run time tracking and other audio content metrics updated such that the combined file appears to the host device 110 as a single file.

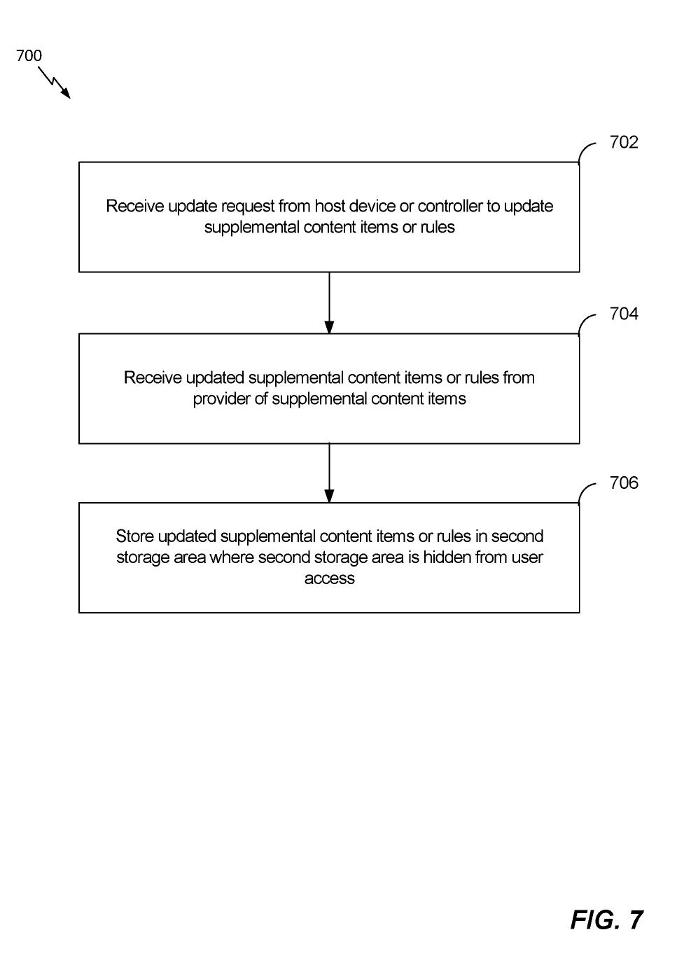

FIG. 7 depicts a particular embodiment of a method of providing supplemental content items to a data storage device for insertion within user data. An update request is received from a host device or controller to update supplemental content items or rules, at 702. For example, when coupled to an external network via the external device/network interface 118 of FIG. 1, a message or command may be received from a provider of the supplemental content items 170 and 174 or from a provider of the data storage device 120 to update the supplemental content items 170 and 174. As another example, the controller 124 may be configured to seek an update, for example, at particular dates or times, after the controller 124 has generated a specified number of augmented content items 180 or 190 (FIG. 2), or after one or more of the supplemental content items 170 and 174 have been used more than a specified number of times. Upon detecting the specified condition, the controller 124 may initiate an update by presenting an update request via the host interface 122 to the host device 110 (FIG. 1). Alternatively, the host device 110 may present an update request. For example, a user may desire to update the supplemental content items and enter a command via the user interface 114 of the host device 110 that causes the processor 112 of the host device 110 to initiate a supplemental content item update via the memory device interface 116.

To verify that the request is received from a provider of supplemental content items and that a user is not attempting to eliminate the supplemental content items or change the rules to stop the introduction of the supplemental content items, the controller 124 may be configured to limit access to the supplemental content items and to the rules for combining the supplemental content items. As part of the update command, the source of the updated material may be authenticated to determine that new or additional supplemental content items or rules are being received from an authorized provider. A command header for an update presented to the data storage device 120 may include an authentication code. The controller 124 may be configured to read the authentication code and compare the authentication code to a stored code prior to granting access to the supplemental content items and to the rules for combining the supplemental content items.

New or additional supplemental content items or rules may be received, at 704. For example, the data storage device 120 may provide a commercial interface that includes an application command to add a commercial file. The application command may provide several items of information about the supplemental content. The update may identify the type or types of added content, such as identifying whether the update includes supplemental content in the form of images, music, video, or other types of media. The application command may specify placement rules for the supplemental content. For example, for an image file, the placement rules may specify at what location or coordinates the supplemental content is to be inserted. For an audio file or video file, the placement rules may indicate at what point in a running time of the audio file or the video file at which the supplemental content is to be inserted. The application command also may identify the size of the supplemental content files, such as a size of an image file or a running time or length of audio or video files. The application command also may specify a number of times or a frequency with which each of the supplemental content items is to be used.

The controller 124 may return information about the data storage device 120 via the host interface 122. The information may include, for example, whether the data storage device 130 has storage space in the second storage area 128 to accommodate the added commercial file or whether the controller's firmware supports addition of the file type of the added commercial file. The information may also include observed placement rules, such as by providing a bit map indicating a location at which an advertisement is to be inserted in an image file or by providing running time indicators specifying at what point an advertisement may be inserted into an audio or video file.

New or updated selection and placement rules received via the application command may be stored with the commercial file, such as in a header or in metadata, or stored in a separate file. For example, metadata of a supplemental content item may include a specified flag bit or status bit at a specified location, such as a bit zero location. When the new supplemental content item is of a dynamic audio or video media type and the specified flag bit has a zero value, the new supplemental content item may be inserted at a midpoint of the user content. Alternatively, when the new supplemental content item is of a dynamic audio or video media type and the specified flag bit has a one value, the new supplemental content item may be inserted at or appended to a beginning of the user content. New or additional supplemental content items of a static type, such as an image or a text type, may include similar flag or status bits that specify whether the supplemental content items are to be inserted in particular corners or along particular edges of the particular user content.

Updated supplemental content items or rules may be stored in a second storage area where the second storage area is hidden from user access, at 706. For example, the controller 124 may write the new or additional supplemental content items to locations in the second storage area 128 specified via the commercial interface. As a result, some of the new or additional supplemental content items may overwrite existing supplemental content items stored in the second storage area 128. Alternatively, the controller 124 may access the file table 150, which may maintain information about the availability of storage locations in the second storage area 128, and the controller 124 may store the new or additional supplemental content items at the available locations in the second storage area 128.

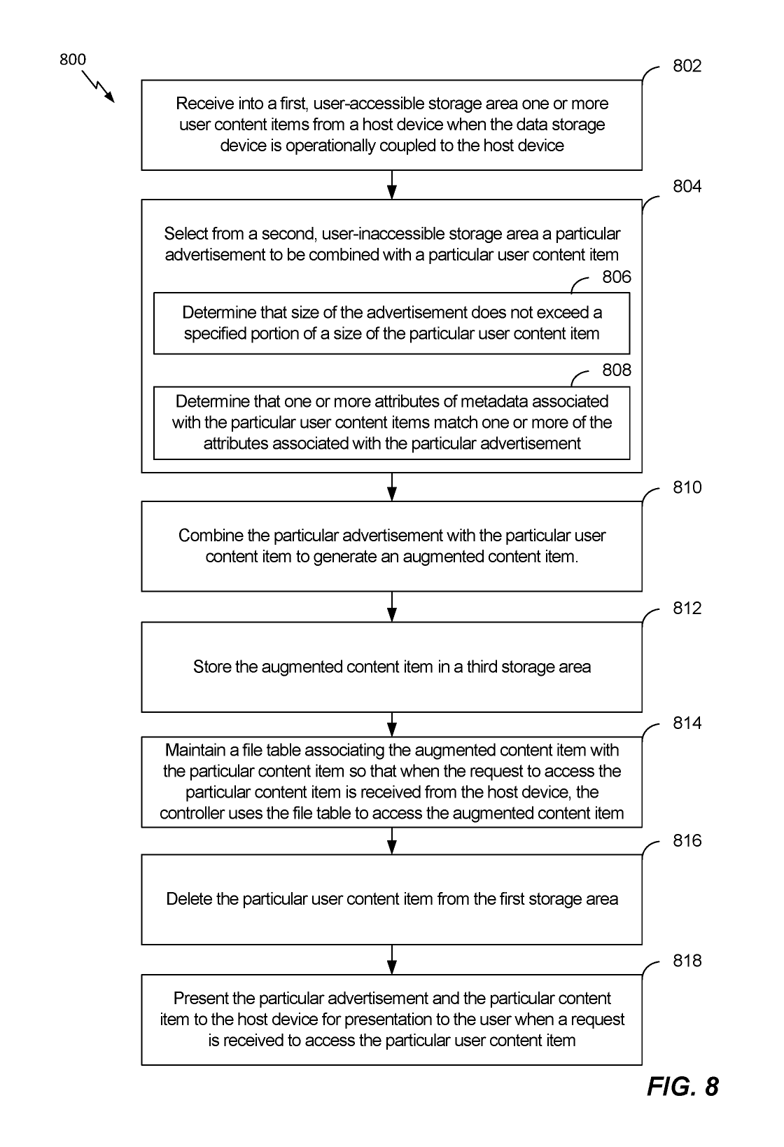

Referring to FIG. 8, a particular embodiment of a method of receiving user content items and generating augmented content items at a data storage device is depicted and generally designated 800. The method 800 may be performed at a controller of a data storage device, such as the controller 124 of the data storage device 120. The data storage device includes a first storage area and a second storage area. The first storage area is accessible by a user, such as the first storage area 126 of FIG. 1. The second storage area is inaccessible to the user and is designated as the storage of one or more advertisements, such as the second storage area 128 of FIG. 1.

The method 800 includes receiving into a first, user-accessible storage area one or more user content items from a host device when the data storage device is operationally coupled to the host device, at 802. For example, with reference to the host device 110 and the data storage device 120 of FIG. 1, the user content item may be received from the host device 110 via a pre-defined data transfer specification protocol, such as a Secure Digital® (SD®) data transfer protocol for communication between the host device 110 and the data storage device 120. The user content items provided may be pre-recorded user content items, such as music files already stored on another data storage device that is accessible to the host device 110. Alternatively, the user content items may include data being contemporaneously captured by the host device, such as images captured by a digital camera, audio files captured by a digital audio recorder, or video files captured by a video recorder. In either case, the host device 110 may direct the user content items to the memory device interface 116 of the host device 110 where data describing the user content items is passed to the data storage device 120 via the host interface 122 of the data storage device 120.

When the one or more user content items are received from the host device at 802, data representing the user content items is received by the controller 124 via the host interface 122. The controller 124 causes the data representing the user content items to be stored at available locations in the first storage area 126. The controller 124 may consult the file table 150 to identify available storage locations in the first storage area 126. The data will be stored as user content items 136 in the first storage area 126. Referring to FIG. 2, the controller 124 will cause an entry to be created in the file table 150, which may include a FAT or a file directory, to log the location of the user content item in the first storage area 126. Encoded data may be received at the data storage device 120 via the host interface 122 when the host interface 122 is operationally coupled to the memory device interface 116. The host interface 122 or the controller 124 may be configured to decode or decompress the received data. If the controller 124 is not configured or otherwise not able to perform the decompression, the controller 124 may communicate the compressed data via the host interface 122 to the host device 110 (FIG. 1) to enable the host device 110 to decompress the data.

Referring again to FIG. 8, from a second, user-inaccessible storage area, a particular advertisement is selected to be combined with a particular user content item, at 804. The particular advertisement may be selected, in part, upon determining that the size of the advertisement does not exceed a specified portion of a size of the particular user content, at 806. When the particular user content item 162 is of a static media type, the selection and placement rules 178 may limit a size of the supplemental content item 170 to, for example, not more than ten percent of the content of the file. Thus, the controller 124 may access the header or the metadata of the particular user content item to determine the size of the particular user content item. The controller 124 then may access the supplemental content items in the second storage area 128 and identify one or more of the supplemental content items that have a size that does not exceed the size limit. Alternatively, the controller 124 may reduce a size of a supplemental content item to satisfy the stated size threshold. When the particular user content item 162 is of the dynamic type, the supplemental content item may be constrained to being of a duration that does not exceed a specified duration or a specified portion of the running time of the particular user content.

The particular advertisement also may be selected, in part, by matching one or more attributes of the metadata associated with the particular user content item with one or more of the attributes associated with the particular advertisement, at 808. The controller 124 may access the selection and placement rules 178 stored separately in the second storage area 128 or stored as part of the supplemental content items to identify one or more metadata attributes to match, as described at 606 of FIG. 6.

Once the particular advertisement is selected at 804, the particular advertisement is combined with the particular user content item to generate an augmented content item, at 810. For a particular user content item of a static media type being combined with a particular advertisement of a static media type, the particular advertisement is inserted in or superimposed over a specified portion of the particular user content item as described with reference to 610 of FIG. 6. For a particular user content item of a dynamic media type being combined with a particular advertisement, the particular advertisement is inserted at a beginning of or at a midpoint of the dynamic particular user content item as described with reference to 620 of FIG. 6.

Combining the particular advertisement (i.e. the particular supplemental content item) with the particular user content item may be performed by identifying a location within the particular user content item corresponding to a specified location to insert the particular supplemental content item and writing data from the particular supplemental content item to the identified location within the particular user content item. For example, identifying the location may include reading an indication of the specified location from a rule corresponding to the particular supplemental item, reading the file table to identify one or more consecutive regions of data corresponding to the particular user content item, and sequentially accessing the one or more consecutive regions of data until a position index within an accessed region corresponds to the specified location. For example, a region of data may correspond to a cluster, a logical block address (LBA), a block, a page, a sector, or other unit.

When the particular user content item is an image file such as a JPEG file, writing the data to the identified location may include deleting one or more blocks of image data at the identified location and replacing the one or more deleted blocks with data corresponding to the particular advertisement. When the particular user content item is an image file having a bitmap format, writing the data to the identified location may include deleting one or more lines of image data at the identified location and replacing the one or more deleted lines with data corresponding to the particular advertisement.

When the particular user content item is an audio or video file, writing the data to the identified location may include decoding at least a portion of the particular user content item to generate decoded data corresponding to the identified location. For example, the decoding may include an entropy decoding of one or more frames within the audio file or the video file. The decoded data corresponding to the identified location may be replaced with advertisement data of the particular advertisement, and the portion of the particular user content item including the advertisement data may be re-encoded, such as an entropy encoding. As another example, when the identified location is a beginning of the audio or video file, such as when the advertisement is to be appended to the user content item “on the fly,” writing the data to the identified location may include initiating a playback of the particular advertisement and initiating a playback of the particular user content item after playback of the particular advertisement. The playback of the user content item and the particular advertisement may be sequentially performed to result in a continuous or near-continuous playback data stream that is presented to a host device. One or more tracking metrics, such as a run time tracking metric, during the playback of the particular user content item may be updated such that the particular advertisement and the particular user content item are presented as a single audio or video file.

An augmented content item may be presented “on the fly” or the augmented content item may be stored in the third storage area 130, at 810. When the particular augmented content item 180 is to be stored, the controller 124 accesses the file table 150 to identify an available storage location in the third storage area 130 that can accommodate the particular augmented content item. The controller 124 then stores the augmented content item at the identified storage location and updates the file table to identify where the particular augmented content item is stored.

The file table associating the augmented content item with the particular user content item is maintained so that, when a request to access the particular user content item is received from the host device, the controller can use the file table to access the augmented content item, at 814. After the controller 124 causes the augmented content item to be stored in the third storage area 130 and enters the augmented content item in the file table 150 as described with reference to 810, the controller 124 associates the particular user content item included in the augmented content item with the augmented content item. Thus, when the request is received by the controller 124 via the host device 110 to access the particular user content item 132, the controller 124 can access an entry in the file table 150 that references the particular user content item 132 to be redirected to the augmented content item stored in the third storage area 130.

After the augmented content item including the particular user content item is stored at 812 and the file table is maintained to redirect requests for the particular user content item at 814, the particular user content item is deleted from the first storage area, at 816. When the particular user content item 132 is not combined with the particular advertisement “on the fly” and is stored in the third data storage area 130, because the particular user content item 132 is thereafter presented as part of the augmented content item, the storage area occupied by the particular user content item 132 can be released to receive other user content items. Thus, the controller 124 updates the file table 150 to identify the storage locations occupied by the particular user content item 132 as free. The freed storage locations may be erased by the controller 124 as part of a block erase. The freed storage locations may be collected by the controller 124 as part of a storage reclamation (i.e., “garbage collection”) process.

When a request is received to access the particular user content item, the particular advertisement and the particular content item are presented to the host device for presentation to the user, at 818. The particular advertisement and the particular content item may be generated “on the fly” as described with reference to 610 and 620 of FIG. 6. Alternatively, when the particular advertisement and the particular user content item are stored together as the particular augmented content item 180 in the third storage area 130, when the controller 124 receives the request for the particular user content item, the controller 124 accesses the file table 150 to determine the augmented content item that includes the particular user content item 132. The controller 124 then passes the augmented content item 180 to the host interface 122 such as by using a Secure Digital® (SD®) data transfer protocol for communication between the host device 110 and the data storage device 120.

Although the method 800 of FIG. 8 includes storing the augmented content item, maintaining the file table, and deleting the original user content item, at 812-816, in other embodiments the augmented content item may be generated “on the fly” and storage, maintenance, and deletion as recited at 812-816 may be omitted.

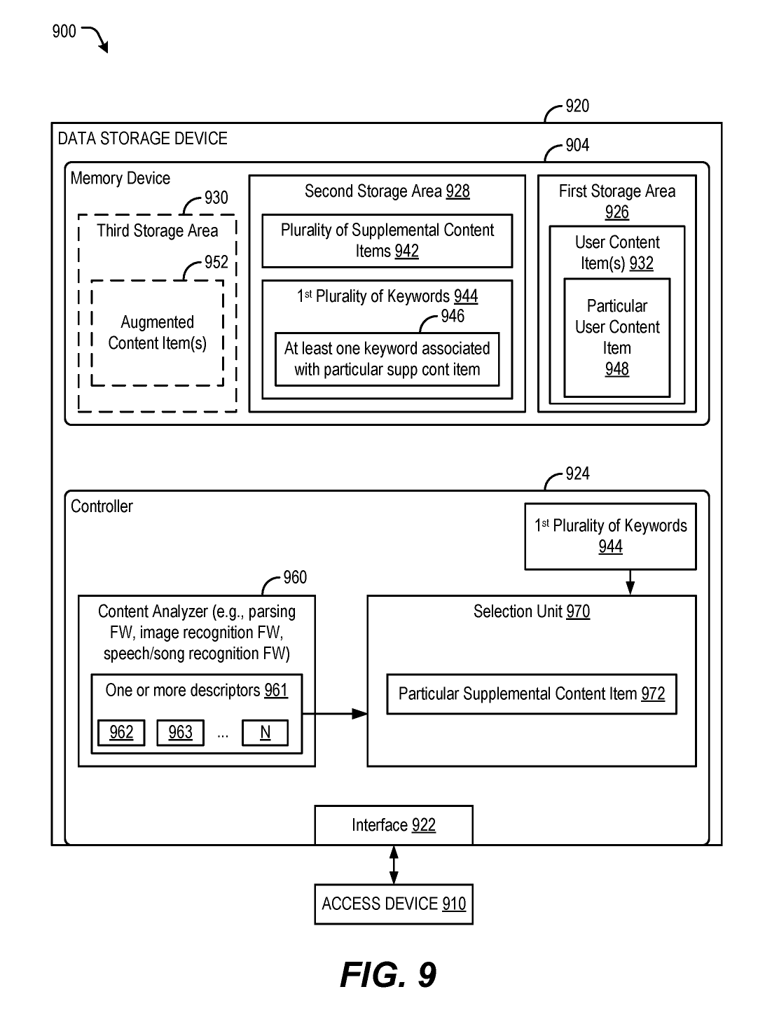

Referring to FIG. 9, a first implementation of a system to combine user content items and supplemental content items is shown and generally designated 900. The system 900 includes a data storage device 920 operatively coupled to an access device 910. The data storage device 920 is configured to selectively combine one or more user content items with one or more supplemental content items, such as advertisements, and to generate augmented content items that include both a user content item and a supplemental content item. The supplemental content items may be identified and selected based on descriptors associated with the one or more user content items. As a result, when a request is made to the data storage device 920 to retrieve a user content item, the data storage device 920 may return an augmented content item that includes both the requested user content combined with one or more advertisements or promotional items.

The access device 910 is operatively coupled to the data storage device 920 to enable storage of user content items at the data storage device 920, retrieval of user content items from the data storage device 920, or both. The access device 910 may include or correspond to, and may perform operations as described with reference to, the host device 110 of FIG. 1.

The data storage device 920 includes an interface 922, a memory device 904, and a controller 924 coupled to the memory device 904 and to the interface 922. The data storage device 920, the interface 922, and the controller 924 may include or correspond to the data storage device 120, the host interface 122, and the controller 124 of FIG. 1. For example, the controller 924 and the interface 922 may operate as described with reference to the controller 124 and the host interface 122 of FIG. 1.

The memory device 904 may include one or more memory dies (e.g., one memory die, two memory dies, eight memory dies, or another number of memory dies). The memory device 904 includes a memory, such as a non-volatile memory of storage elements included in a memory die of the memory device 904. The memory may include a flash memory (e.g., a NAND flash memory, a NOR flash memory, etc.) or a resistive random access memory (ReRAM), as illustrative, non-limiting examples. In some implementations, the memory may include or correspond to a memory die of the memory device 904. The memory may have a three-dimensional (3D) memory configuration. As an example, the memory may have a 3D vertical bit line (VBL) configuration. In a particular implementation, the memory device 904 includes a non-volatile memory having a 3D memory configuration that is monolithically formed in one or more physical levels of arrays of memory cells having an active area disposed above a silicon substrate. Alternatively, the memory may have another configuration, such as a two-dimensional (2D) memory configuration or a non-monolithic 3D memory configuration (e.g., a stacked die 3D memory configuration).

The memory device 904 may include one or more blocks, such as a NAND flash erase group of storage elements. Each storage element of the memory device 904 may be programmable to a state (e.g., a threshold voltage in a flash configuration or a resistive state in a resistive memory configuration) that indicates one or more values. For example, the memory device 904 may be configured to store data. Each block of the memory device 904 may include one or more word lines. Each word line may include one or more pages, such as one or more physical pages. In some implementations, each page may be configured to store a codeword. A word line may be configurable to operate as a single-level-cell (SLC) word line, as a multi-level-cell (MLC) word line, or as a tri-level-cell (TLC) word line, as illustrative, non-limiting examples.

In a particular implementation, the memory device 904 includes a first storage area 926, a second storage area 928, and a third storage area 930. Each storage area of the storage areas 926-930 may include one or more storage cells configured to store one or more bits of data. The storage areas 926-930 may include or correspond to the respective storage areas 126-130 of FIG. 1. The first storage area 926 may be accessible to a user of the access device 910 and may store one or more user content items, such as media files, audio files (e.g., speech files, music files, etc.), text documents (e.g., reports, e-mails, notes, etc.), image items (e.g., photos, video frames, etc.), or a combination thereof. The second storage area 928 may not be accessible to the user and stores a plurality of supplemental content items 942, such as advertisements, promotional items, or other content that an advertiser or other organization may desire to provide to a user of the data storage device 920. The second storage area 928 may also store a first plurality of keywords 944 that are associated with the plurality of supplemental content items 942. Firmware of the controller 924 may be configured to maintain the separate storage areas 926, 928, and 930 and to restrict user access to the second storage area 928. The first storage area 926, the second storage area 928, and the third storage area 930 each may be implemented in a non-volatile memory device or a volatile memory device.

The controller 924 is configured to receive one or more user content items from the access device 910 when the data storage device 920 is operationally coupled to the access device 910 via the interface 922. User content items received via the interface 922 may be stored by the controller 924 as one or more user content items 932 in the first storage area 926.

The controller 924 is configured to analyze content of the user content items 932 to determine a supplemental content item to combine with a user content item to generate an augmented content item. To illustrate, the controller 924 may include a content analyzer 960 configured to analyze content of a particular user content item 948 of the user content items 932 to determine one or more descriptors 961, such as keywords, objects, characteristics, or other indicators of the content of the user content items that are related to the particular user content item 948. To illustrate, the content analyzer 960 may be configured to determine a file type of the particular user content item 948 and to perform one or more recognition or other processing operations on the particular user content item 948 based on the file type. The particular user content item 948 may be a text file, an image file (e.g., a picture), an audio file, such as a speech file or a music file, or other file type. The content analyzer 960 may be configured to perform one or more recognition or processing operations that correspond to the file type of the particular user content item 948 to determine the one or more descriptors 961.

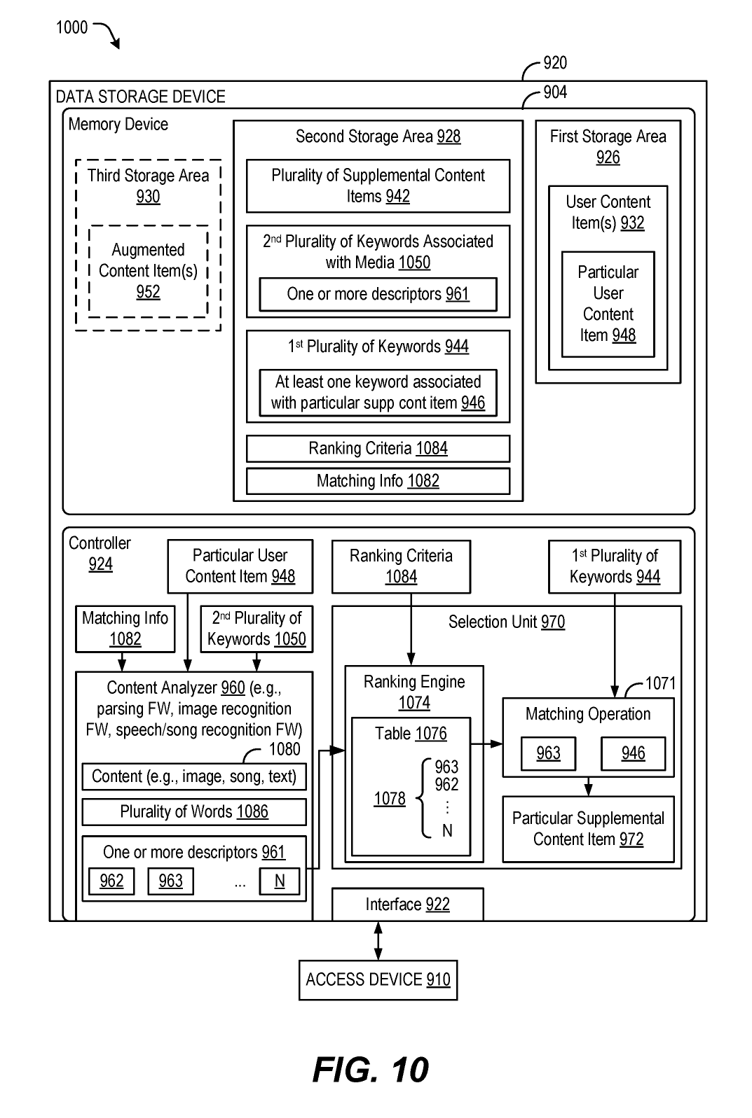

The content analyzer 960 may be configured to automatically choose a suitable mode of content analysis based on the type of the user content (e.g., text, speech, visual, etc.). For example, the content analyzer 960 may include parsing firmware (FW) configured to parse text files and to determine one or more words (e.g., the one or more descriptors 961) that are relevant to the text file. When the user content includes a text file, the content analyzer 960 may choose the parsing FW to analyze the user content. In a particular implementation, the words may be high frequency words or words in a title, as further described with reference to FIG. 10. The identified words (e.g., the one or more descriptors 961) may be used to match to the first plurality of keywords 944, as further described herein.

As another example, the content analyzer 960 may include image recognition FW configured to identify visual objects within pictures or other images, and the content analyzer 960 may choose the image recognition FW to analyze user content when the user content includes pictures or other images. Words associated with visual objects may be determined based on a database (or other structure) that stores information to map objects to corresponding words. The identified words (e.g., the one or more descriptors 961) may be used to match to the first plurality of keywords 944, as further described herein.

As another example, the content analyzer 960 may include speech/song recognition FW configured to perform speech recognition on speech files to determine words that appear in the speech files, and the content analyzer 960 may choose the speech/song recognition FW to analyze user content when the user content includes audio content. In a particular implementation, the words may be ranked by frequency, as further described with reference to FIG. 10. The identified words (e.g., the one or more descriptors 961) may be used to match to the first plurality of keywords 944, as further described herein. The speech/song recognition FW may also be configured to perform song recognition on a music file to identify a song. The speech/song recognition FW may use the song as an index to a database (e.g., an internal database stored at the data storage device 920 or an external database accessible via a network) to determine words that are included in the song, or other characteristics of the song (e.g., an artist, a song name, an album name, a release year, etc.). The identified words or characteristics (e.g., the one or more descriptors 961) may be used to match to the first plurality of keywords 944, as further described herein.

The controller 924 is configured to select a particular supplemental content item 972 of the plurality of supplemental content items 942 based on the one or more descriptors 961. For example, the controller 924 may include a selection unit 970 that is configured to select the particular supplemental content item 972 based on comparing the one or more descriptors 961 to the first plurality of keywords 944. To illustrate, the one or more descriptors 961 may include a first descriptor 962, a second descriptor 963, and an Nth descriptor. Although three descriptors are illustrated, in other implementations, more than three or fewer than three descriptors are determined. The selection unit 970 may be configured to determine one or more keywords of the first plurality of keywords 944 that match the one or more descriptors 961. For example, a first word (e.g., the first descriptor 962) identified by the content analyzer 960 may be the same as at least one keyword 946 of the first plurality of keywords 944. The selection unit 970 may be configured to select the particular supplemental content item 972 based on the particular supplemental content item 972 being associated with the at least one keyword 946. The particular supplemental content item 972 may be used to generate augmented content.

As a particular illustrative example, the particular user content item 948 may include an image of two cars driving by a tree and a house. The content analyzer 960 may perform object recognition on the particular user content item 948 to determine the visual objects car, tree, and house, which correspond to the words “car” (e.g., the first descriptor 962), “tree” (e.g., the second descriptor 963), and “house” (e.g., the Nth descriptor). The selection unit 970 may match the one or more descriptors 961 to keywords of the first plurality of keywords 944. For example, the selection unit 970 may identify a first keyword “car” and a second keyword “house”. The particular supplement content item 972 may be a picture of a car advertisement and may be associated with the first keyword “car”. The selection unit 970 may select the particular supplemental content item 972 based on the match between the first keyword “car” and the first descriptor 962 of the one or more descriptors 961. By selecting a supplemental content item (e.g., a car advertisement) that matches at least a portion of a user content item, the selection unit 970 may provide more relevant advertisements to users than if no matching between descriptors and keywords is performed.

The controller 924 is configured to combine the particular supplemental content item 972 with the particular user content item 948 to generate an augmented content item 952. The particular supplemental content item 972 may of the same media type as the particular user content item 948 or of a compatible media type. For example, the media type may include one or more of a static type, such as an image type or a document/text type, and a dynamic type, such as an audio type or a video type. To illustrate, an image type may include Joint Photographic Expert Group (JPEG) image file format data, while an audio type may include Motion Picture Expert Group (MPEG) Audio Layer 3 (MP3) format data and a video type may include MPEG 4 (MP4) format data.

When the particular user content item 948 is of the image type or the document or text type, the particular supplemental content item 972 may also be of the image type or of the document type or text type, and the augmented content item 952 may include the particular supplemental content item 972 superimposed over a specified portion of the particular user content item 948. For example, the particular supplemental content item 972 may be positioned in a specified corner or along a specified edge of a user image, as is illustrated in FIG. 3A, FIG. 3B, and FIG. 3C. Selection and placement rules may limit selection of the particular supplemental content item 972, for example, to a supplemental content item that has a size that is not more than ten percent of the size of the particular user content item 948. Alternatively, the selection and placement rules may direct the controller 924 to scale a size of the particular supplemental content item 972 so that the particular supplemental content item 972 spans not more than ten percent of the particular user content item 948 when the particular supplemental content item 972 is combined with the particular user content item 948.

As another example, when the particular user content item 948 is of the dynamic type (e.g., an audio type or a video type), the particular supplemental content item 972 may be of a same dynamic type and the augmented content item 952 includes the particular supplemental content item 972 either appended to a beginning of the particular user content item 948 or inserted within the user content audio or video file between a beginning and an end of the particular user content item 948, as is illustrated in FIG. 3D and FIG. 3E. As another example, the particular supplemental content item 972 may have a running time that is not more than a specified portion of a running time of the particular user content item 948. For example, when the particular user content item 948 is an audio file, metadata may indicate that a running time of the audio file is three minutes. The particular supplemental content item 972, such as an audio commercial to be included in the augmented content item 952, may be constrained to a duration that does not exceed a specified commercial duration or a specified portion of the running time of the particular user content item 948. To illustrate, the particular supplemental content item 972 may be limited to a duration of not more than ten seconds or of not more than two percent of the three minute running time, as illustrative, non-limiting examples. Other examples of augmented content items are described with reference to FIGS. 1, 2, and 3A-E.

In a particular implementation, the controller 924 is configured to store the augmented content item 952 in the third storage area 930. The third storage area 930 may be designated to store augmented content items and may be inaccessible to the user. In a particular implementation, the augmented content items are generated and stored during idle time periods (e.g., time periods without performance of read or write operations at the memory device 904), during garbage collection times (e.g., performance of one or more storage reclamation operations or procedures), or during other times when read operations and write operations are not being performed by the data storage device 920. In another particular implementation, augmented content items are not stored at the third storage area 930 and instead are generated “on the fly”, as described with reference to FIGS. 1-2. For example, the augmented content item 952 may be generated based on a request from the access device 910 for the particular user content item 948, and the augmented content item 952 may be provided to the access device 910 in response to the request.

By generating augmented content items based on a comparison between user content items and keywords, the system 900 may generate augmented content items that are more relevant and desirable to a user than if the augmented content is generated in a different manner. To illustrate, by selecting the particular supplemental content item 972 based on a match between one or more associated keywords and the one or more descriptors 961, the particular supplemental content item 972 is more likely to be of relevance or interest to the user (e.g., due to similarities between the particular supplemental content item 972 and the particular user content item 948). Presenting more relevant and interesting content (e.g., the augmented content item 952) may increase a likelihood that the user purchase or use a product or service that is advertised, which may increase revenue to an advertisement supplier.

Referring to FIG. 10, a second implementation of a system to combine user content items and supplemental content items is shown and generally designated 1000. The system 1000 includes the data storage device 920 and access device 910. As described with reference to FIG. 9, the data storage device 920 is configured to generate augmented content items based on user content items and supplemental content items. FIG. 10 illustrates additional details regarding generation of the augmented content items. The data storage device 920 includes the memory device 904 and the controller 924. As described with reference to FIG. 9, the memory device 904 includes the first storage area 926 and the second storage area 928. The first storage area 926 may be configured to store the user content items 932 (including the particular user content item 948), and the second storage area 928 may be configured to store the plurality of supplemental content items 942 and the first plurality of keywords 944. Additionally, the second storage area 928 may be configured to store a second plurality of keywords 1050 that are associated with media, ranking criteria 1084, and matching information 1082. In some implementations, the memory device 904 further includes the third storage area 930 that is configured to store augmented content items, such as the augmented content item 952.

As described with reference to FIG. 9, the controller 924 is configured to generate augmented content items, such as the augmented content item 952, based on the user content items 932 and the plurality of supplemental content items 942. To identify supplemental content items to be used to generate augmented content items, the content analyzer 960 is configured to analyze content 1080 of a particular user content item 948 of the user content items 932 to determine the one or more descriptors 961.

In a particular implementation, the particular user content item 948 includes an image item (e.g., a picture or other image file), and the content analyzer 960 is configured to detect that the type of content 1080 is image content and to automatically select image recognition FW to analyze the content 1080 of the image item to determine at least one object represented in the image item. To illustrate, the content analyzer 960 may perform object recognition to recognize a first car, a second car, a tree, a house, a second tree, a third car, and a truck in the image item. The content analyzer 960 may determine the one or more descriptors 961 based on the at least one object. For example, the one or more descriptors 961 may include words, terms, phrases, identifiers, etc. that correspond to the at least one object. In this example, the one or more descriptors 961 may include “car”, “car”, “tree”, “house”, “tree”, “car”, and “truck”.

The selection unit 970 may be configured to select the particular supplemental content item 972 based on the one or more descriptors 961 and the first plurality of keywords 944. For example, the selection unit 970 may perform a matching operation 1071 to match at least one descriptor of the one or more descriptors 961 to the at least one keyword 946 of the first plurality of keywords 944. As an illustrative example, the matching operation 1071 may identify a match between the descriptor “car” and a first keyword “car” of the first plurality of keywords 944. In some implementations, the matching operation 1071 may produce “exact” matches when a descriptor and a keyword are the same word (e.g., the descriptor and the keyword are “car”). In other implementations, the matching operation 1071 may produce “similar” matches. As an example, the matching operation 1071 may produce a match between the descriptor “car” and the keyword “vehicle” (e.g., based on a similarity score or other metric that relates the descriptor to the keyword). As another example, the matching operation 1071 may produce a match between the descriptor “laptop” and the keywords “computer”, “storage device”, “applications”, “technology”, and “video games.” As described with reference to FIG. 9, after the selection unit 970 determines the at least one keyword 946 that matches at least one of the one or more descriptors 961, the selection unit 970 selects the particular supplemental content item 972.

In another particular implementation, the content analyzer 960 may determine the type of the content 1080 of the particular user content item 948 is speech content (e.g., an audio file containing speech), and the content analyzer 960 is configured to automatically select speech recognition FW to analyze the content 1080 of the speech file by performing speech recognition to detect a plurality of words 1086. To illustrate, the content analyzer 960 may perform speech recognition to generate a transcript that corresponds to the speech. The transcript includes the plurality of words 1086 that are included in the speech. The speech recognition performed by the content analyzer 960 may include model-based speech recognition, speech recognition using neural networks, or any other type of speech recognition. The content analyzer 960 may be configured to compare the plurality of words 1086 and the second plurality of keywords 1050 to determine the one or more descriptors 961. Comparing the plurality of words 1086 to the second plurality of keywords 1050 may identify words included in the plurality of words 1086 that are likely to be associated with supplemental content items. In some implementations, the content analyzer 960 may compare the plurality of words 1086 to the second plurality of keywords 1050 based on the matching information 1082. The matching information 1082 may include information that indicates a number of descriptors to match, a likeliness score that determines a match, one or more parameters for performing a matching operation, other matching information, or a combination thereof. The matching information 1082 may also include characteristic-to-descriptor mapping information, as further described herein.

To illustrate, the content analyzer 960 may analyze a speech file to detect the plurality of words 1086 including “Hi Bob, this is Carmen. Will you stop by the store on the way home? We need milk, light bulbs, and dog food.” One or more words (e.g., “hi”, “this”, “is”, “you”, “the”, “on”, “and”, etc.) of the plurality of words 1086 may be unlikely to be related to media items, such as the plurality of supplemental content items 942. To eliminate words that are unlikely to be related to the plurality of supplemental content items 942, the content analyzer 960 may compare the plurality of words 1086 to the second plurality of keywords 1050. The second plurality of keywords 1050 includes potential descriptors (e.g., keywords) that are likely to be associated with media items, such as the plurality of supplemental content items 942. For example, the second plurality of keywords 1050 may include words such as “store”, “car,” “milk”, “light bulbs”, “toy”, “dog”, “computer,” and “food” (as non-limiting examples) that relate to supplemental content items, such as a coupon for a discount at a store, an advertisement for milk, an advertisement for a car, a link to an article comparing brands of light bulbs, a picture of a new toy, a video of a dog show, or other supplemental content (e.g., media content). In a particular implementation, the second plurality of keywords 1050 is stored at the second storage area 928 of the memory device 904 during manufacture of the data storage device 920 or by a distributor prior to providing the data storage device 920 to a user. In another particular implementation, the second plurality of keywords 1050 is updated during operation of the data storage device 920. For example, the controller 924 may be configured to access a network connection (e.g., when the data storage device 920 is coupled to the access device 910 that is connected to a network) to update the second plurality of keywords 1050. Additional data stored at the data storage device 920, such as the plurality of supplemental content items 942, the first plurality of keywords 944, the ranking criteria 1084, the matching information 1082, other information, or a combination thereof, may be updated in a similar manner.

The content analyzer 960 may be configured to determine the one or more descriptors 961 by determining one or more words of the plurality of words 1086 that match one or more keywords of the second plurality of keywords 1050 (e.g., the one or more descriptors 961 are included in both the second plurality of keywords 1050 and the plurality of words 1086). For example, the content analyzer 960 may determine that the one or more descriptors 961 include the words “store”, “milk”, “light bulbs”, “dog”, and “food”. Filtering the plurality of words 1086 using the second plurality of keywords 1050 (e.g., determining the one or more descriptors 961 based on a comparison of the plurality of words 1086 and the second plurality of keywords 1050) may improve performance of the selection unit 970, as further described herein. Additionally, the content analyzer 960 may use the second plurality of keywords 1050 when determining the one or more descriptors 961 for other types of user content items. As a non-limiting example, the content analyzer 960 may compare the one or more objects identified in an image file to the second plurality of keywords 1050 to determine the one or more descriptors 961.

In a particular implementation, the controller 924 (e.g., the selection unit 970) is configured to rank each descriptor of the one or more descriptors 961 based on the ranking criteria 1084. To illustrate, the selection unit 970 may include a ranking engine 1074 that is configured to rank the one or more descriptors 961 based on the ranking criteria 1084. The ranking criteria 1084 may include one or more criteria for ranking descriptors, and the ranking criteria 1084 may be stored at the second storage area 928 of the memory device 904 prior to the data storage device 920 being provided to a user. In a particular implementation, the ranking criteria 1084 includes descriptor occurrence frequency (e.g., descriptors are weighted based on frequency of occurrence). In another particular implementation, the ranking criteria 1084 includes criteria that associate descriptors in a title (or descriptors associated with a particular characteristic) are weighted higher than other descriptors. In another particular implementation, the ranking criteria 1084 ranks descriptors based on revenue collected from associated entities (e.g., advertisers, providers, etc.). Thus, the ranking criteria 1084 may include multi-factor weighting and ranking.

The ranking engine 1074 may be configured to receive the one or more descriptors 961 from the content analyzer 960 and to rank the one or more descriptors 961 based on the ranking criteria 1084. In a particular implementation, the ranking criteria 1084 includes descriptor occurrence frequency, and the ranking engine 1074 is configured to determine a number of occurrences in the speech file (or other type of user content item) of each descriptor of the one or more descriptors 961. As a particular example, the one or more descriptors may include the first descriptor 962 that occurs twice, the second descriptor 963 that occurs five times, and the Nth descriptor (“N”) that occurs a single time. The ranking engine 1074 may generate a ranking table 1076 that ranks each descriptor of the one or more descriptors 961 based on the number of occurrences of the one or more descriptors 961 in the speech file (e.g., the content 1080 of the particular user content item 948). For example, the ranking table 1076 may include an ordered ranking 1078 of the one or more descriptors 961. In the example illustrated in FIG. 10, the second descriptor 963 is ranked first (e.g., based on the five occurrences), the first descriptor 962 is ranked second (e.g., based on the two occurrences), and the Nth descriptor is ranked third (based on the single occurrence). The example is illustrative, and in other implementations the ordered ranking 1078 may be a different order (e.g., based on different frequencies of occurrence, based on descriptors in titles, based on descriptor weights, or other ranking criteria).

The ranking engine 1074 may select one or more prioritized descriptors from the ranking table 1076. A number M of prioritized descriptors to be selected may be indicated by the ranking criteria 1084 (or other information), where M is any integer greater than zero. In a particular implementation, the selection unit 970 is configured to perform a matching operation 1071 to match a prioritized descriptor to at least one keyword of the first plurality of keywords 944 that is associated with the particular supplemental content item 972. For example, the selection unit 970 may match the second descriptor 963 (e.g., the prioritized descriptor) to the at least one keyword 946, as described with reference to FIG. 9. The prioritized descriptor (e.g., the second descriptor 963) may be selected from the one or more descriptors 961 based on the ranking table 1076 (e.g., due to the second descriptor 963 being the highest ranked descriptor in the ranking table 1076). In other implementations, multiple descriptors may be selected from the one or more descriptors 961 and used to perform the matching operation 1071. As described with reference to FIG. 9, after the selection unit 970 determines the at least one keyword 946 that matches at least one of the one or more descriptors 961, the selection unit 970 selects the particular supplemental content item 972.

In another particular implementation, the particular user content item 948 includes a text file, and the content analyzer 960 is configured to determine that the type of the content 1080 is a text type and to automatically select parsing FW to analyze the content 1080 of the text document by performing word recognition to detect the plurality of words 1086 in the text document. To illustrate, the content analyzer 960 may perform word recognition to generate a transcript that corresponds to the text file and that includes the plurality of words 1086. The word recognition may be performed using any word or text recognition operations. The content analyzer 960 may be configured to determine the one or more descriptors 961 based on a comparison of the plurality of words 1086 to the second plurality of keywords 1050. For example, the content analyzer 960 may identify matches between the plurality of words 1086 and the second plurality of keywords 1050 to determine the one or more descriptors 961.

In a particular implementation, the controller 924 (e.g., the selection unit 970) is configured to rank each descriptor of the one or more descriptors 961 based on the ranking criteria 1084, as described herein. In a particular implementation, the ranking criteria 1084 includes descriptor occurrence frequency, ranking based on descriptors being in a title (or other particular document element), or both, and the ranking engine 1074 is configured to determine a number of occurrences in the text file of each descriptor of the one or more descriptors 961 and whether each descriptor is in the title (or another particular document element). As a particular example, the second descriptor 963 is located in the title and occurs twice, the first descriptor 962 is not located in the title and occurs twice, and the Nth descriptor (“N”) is not located in the title and occurs a single time. The ranking engine 1074 may be configured to generate the ranking table 1076 that ranks each descriptor of the one or more descriptors 961 based on the number of occurrences of the one or more descriptors 961 in the text file, the location of the one or more descriptors 961, or both. For example, the second descriptor 963 may be ranked first (e.g., based on being located in the title and occurring twice), the first descriptor 962 may be ranked second (e.g., based on not being located in the title and occurring twice), and the Nth descriptor is ranked third (based on not being located in the title and occurring once).

The selection unit 970 may be configured to perform the matching operation 1071 to match a prioritized descriptor to at least one keyword of the first plurality of keywords 944 that is associated with the particular supplemental content item 972. For example, the selection unit 970 may match the second descriptor 963 (e.g., the prioritized descriptor) to the at least one keyword 946, as described with reference to FIG. 9. The prioritized descriptor (e.g., the second descriptor 963) may be selected from the one or more descriptors 961 based on the ranking table 1076 (e.g., due to the second descriptor 963 being the highest ranked descriptor in the ranking table 1076). In other implementations, multiple descriptors may be selected from the one or more descriptors 961 and used to perform the matching operation 1071. As described with reference to FIG. 9, after the selection unit 970 determines the at least one keyword 946 that matches at least one of the one or more descriptors 961, the selection unit 970 selects the particular supplemental content item 972.

In another particular implementation, the particular user content item 948 includes a music file (e.g., an audio music file), and the content analyzer 960 is configured to analyze the content 1080 of the music file to determine at least one characteristic of the music file and to determine the one or more descriptors 961 based on the at least one characteristic. The at least one characteristic may include a song title, an album title, an artist, a genre, a release year, a publisher, other characteristics, or a combination thereof. The matching information 1082 may include information that maps characteristics to potential descriptors. For example, the matching information 1082 may include information that maps a song title to one or more potential descriptors. The at least one characteristic and the matching information 1082 may be used to determine the one or more descriptors 961. To illustrate, the music file may include a song, the content analyzer 960 may determine a name of the song (e.g., a song title), and the content analyzer 960 may determine the one or more descriptors 961 as the potential descriptors that are mapped to the name of the song based on the matching information 1082. As a particular example, the content analyzer may identify a song “You Might Believe”, and the one or more descriptors 961 may include an artist name (“Johnny Oldman”), a second artist name (“The Oldman Band”), and a name of another media content item related to the song (“Toy Tales”). After the one or more descriptor 961 are determined, the selection unit 970 may determine the particular supplemental content item 972 based on the one or more descriptors 961 and the first plurality of keywords 944 (and in some implementations the ranking criteria 1084), as described herein.

During operation, the controller 924 initiates generation of augmented content items. In a particular implementation, the controller 924 initiates generation of augmented content items based on detection of an idle time period (e.g., read or write inactivity) or based on performance of one or more garbage collection operations at the memory device 904. In another particular implementation, the controller 924 initiates generation of augmented content items in response to receiving the user content items 932 for storage at the memory device 904. In other implementations, the controller 924 initiates generation of augmented content items in response to receiving requests for the user content items 932 stored at the memory device 904.

When the particular user content item 948 is selected for use in generating augmented content, the content analyzer 960 may identify a type of the particular user content item 948 and may determine one or more analysis operations to perform based on the type. For example, the content analyzer 960 may perform speech recognition operations based on a speech file, image recognition operations based on an image item, song recognition operations based on a music file, or text parsing and word recognition operations based on a text file (e.g., a text document, an e-mail, etc.), as non-limiting examples. The content analyzer 960 may determine the one or more descriptors 961 based on the content 1080 of the particular user content item 948, and the selection unit may select the particular supplemental content item 972 based on a comparison of the one or more descriptors 961 to the first plurality of keywords 944. For example, the selection unit 970 may perform the matching operation 1071 to identify the at least one keyword 946, and the selection unit 970 may select the particular supplemental content item 972 based on the particular supplemental content item 972 being associated with the at least one keyword 946. In some implementations, the ranking engine 1074 ranks the one or more descriptors 961 based on the ranking criteria 1084, and the matching operation 1071 is performed based on prioritized (e.g., ranked) descriptors. After the particular supplemental content item 972 is identified, the controller 924 combines the particular user content item 948 and the particular supplemental content item 972 to generate the augmented content item 952. The augmented content item 952 may be stored at the third storage area 930 or provided to the access device 910 in response to a request for the particular user content item 948.

Because the system 1000 of FIG. 10 enables selection of a supplemental content item based on descriptors related to the content of a user content item, an appropriateness of the supplemental content item may be enhanced as compared to random selection of the supplemental content item. As a result, a user experience related to the resulting augmented content item may be enhanced. An effectiveness of the supplemental content item may also be enhanced, such as when the supplemental content item includes an advertisement that is related to the content of the user content item as compared to an advertisement that is unrelated to the content of the user content item. Using prioritized (e.g., ranked) descriptors to determine the supplemental content may further enhance the effectiveness of the supplemental content and the user experience related to the resulting augmented content item.

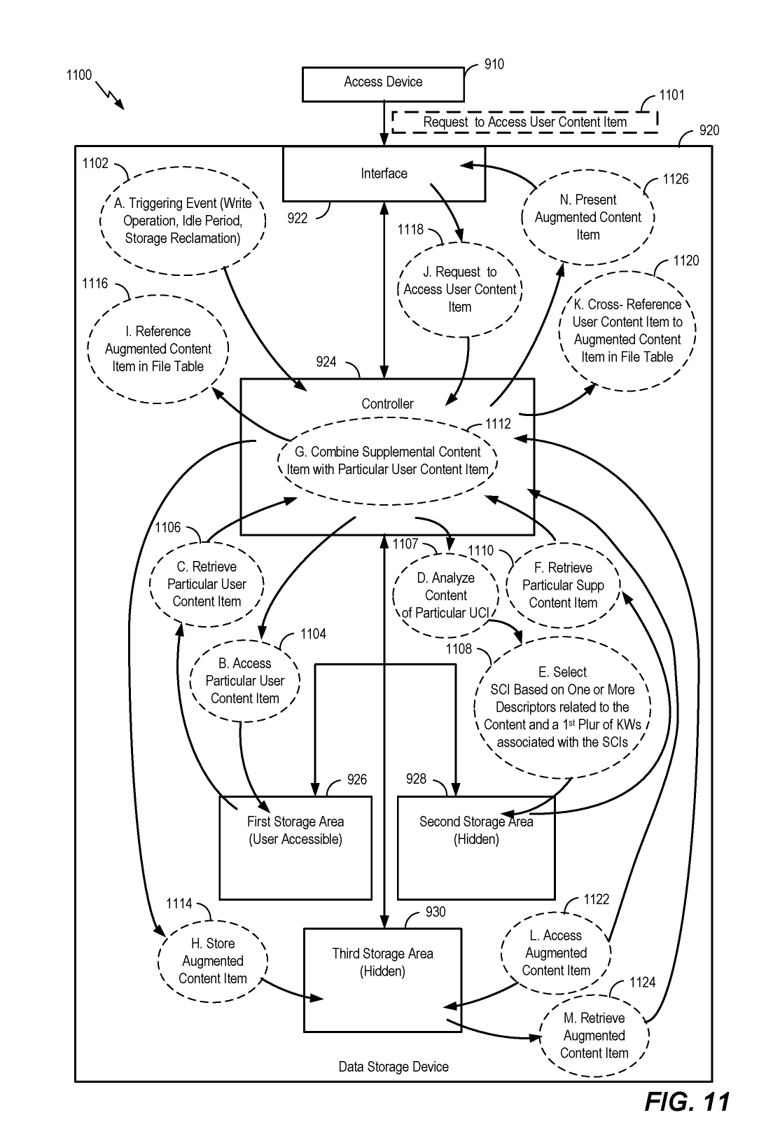

FIG. 11 depicts a particular embodiment of a data flow diagram 1100 of operations of the data storage device 920 where an augmented content item is generated independently of any request (e.g., without receiving any request) from the access device 910. A triggering event may be detected, at 1102, by the controller 924. For example, the triggering event may include a write operation occurring at the first storage area 926, such as an addition of user content to the data storage device 920. Another example of a triggering event may be an idle period resulting from no read operations or write operations being performed at the data storage device 920 (e.g., read and write inactivity). As another example, the triggering event may be associated with commencement of or operation of a storage reclamation procedure (e.g., a “garbage collection”) at the data storage device 920 into which the first storage area 926 is incorporated. In response to the triggering event, the controller 924 may initiate access to the first storage area 926 to access a particular user content item, at 1104. The controller 924 may retrieve the particular user content item, at 1106.

After retrieving the particular user content item, the controller 924 may analyze content of the particular user content item, at 1107, and may identify one or more descriptors associated with the content, such as the one or more descriptors 961 of FIGS. 9-10. The controller 924 may initiate selection of a supplemental content item, at 1108, based on one or more of the descriptors related to the content and further based on a first plurality of keywords associated with the supplemental content items, such as the first plurality of keywords 944 of FIGS. 9-10. The supplemental content item may be stored at the second storage area 928.

The controller 924 may retrieve the supplemental content item from the second storage area 928, at 1110. The controller 924 may combine the supplemental content item with the particular user content item, at 1112, to create an augmented content item that may be stored to the third storage area 930, at 1114, and referenced in a file table, at 1116.

After storing the augmented content item to the third storage area 930, the data storage device 920 may receive a request 1101 to access the user content item sent from the access device 910 and may process, at 1118, the request 1101 to access the user content item. The controller 924 may access the file table, such as the file table 150 of FIG. 2, and may cross-reference the user content item to the augmented content item stored in the third storage area 930, at 1120. Having cross-referenced the user content item to locate the augmented content item at the third storage area 930, the controller 924 may access the augmented content item, at 1122, and retrieve the accessed augmented content item, at 1124. The accessed augmented content item may be provided by the controller 924 to the interface 922 to present the augmented content item at the interface 922, at 1126, and the augmented content item may be retrieved by the access device 910.

By generating an augmented content items based on a comparison between user content items and keywords, the data storage device 920 may generate augmented content items that are more relevant to the subject matter of the user content item than if the augmented content is generated in a different manner. The selected supplemental content item is likely to exhibit similarities with the particular user content item that may enhance a user experience as compared to a supplemental content item that is unrelated to the user content item.

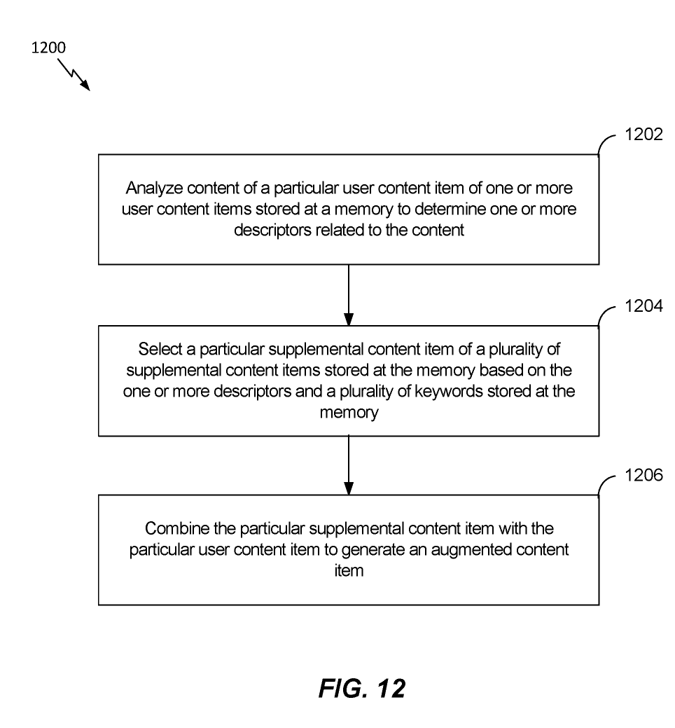

Referring to FIG. 12, a particular embodiment of a method of generating augmented content items at a data storage device is depicted and generally designated 1200. The method 1200 may be performed at a controller of a data storage device, such as the controller 124 of the data storage device 120, the controller 924 of the data storage device 920 of FIG. 9, or the controller 924 of the data storage device 920 of FIG. 10, as illustrative, non-limiting examples.

The method 1200 includes analyzing content of a particular user content item of one or more user content items stored at a memory to determine one or more descriptors related to the content, at 1202. For example, the content analyzer 960 may analyze content of the particular user content item 948 and may generate the one or more descriptors 961.

The method 1200 includes selecting a particular supplemental content item of a plurality of supplemental content items stored at the memory based on the one or more descriptors and a first plurality of keywords stored at the memory, at 1204. For example, the selection unit 970 may select the particular supplemental content item 972 based on the one or more descriptors 961.

The method 1200 includes combining the particular supplemental content item with the particular user content item to generate an augmented content item, at 1206. For example, the controller 924 may combine the particular user content item 948 with the particular supplemental content item 972 to generate an augmented content item for storage in the third storage area 930.

In some implementations, a request for the particular user content item may be received from an access device, and the augmented content item may be sent to the access device in response to receiving the request. For example, the controller 924 may update a file table to associate the augmented content item 952 with the particular user content item 948. Upon receiving a request for the particular user content item 948 (e.g., the request including an LBA corresponding to the particular user content item 948), the controller 924 may map the request instead to the augmented content item 952. In some implementations, the controller 924 may delete the particular user content item 948 after creating the augmented content item 952.

In some implementations, the augmented content item may be stored at the memory, and the augmented content item may be generated during an idle time period (e.g., a time period without performance of read or write operations at the memory device 904) or performance of a garbage collection operation. For example, the controller 924 may initiate generation of one or more augmented content items based on detecting an idle period at the data storage device 920 or based on performing one or more garbage collection operations at the memory device 904.

In some implementations, the plurality of supplemental content items, the first plurality of keywords, or both may be updated during an operational lifetime of the memory. For example, the controller 924 may access a network connection of the access device 910 to update data stored at the memory device 904, including the plurality of supplemental content items 942, the first plurality of keywords 944, the second plurality of keywords 1050, the ranking criteria 1084, the matching information 1082, or a combination thereof.

By selecting a supplemental content item based on descriptors related to the content of the user content item, an appropriateness of the supplemental content item may be enhanced as compared to random selection of the supplemental content item. As a result, a user experience related to the resulting augmented content item may be enhanced. An effectiveness of the supplemental content item may also be enhanced, such as when the supplemental content item includes an advertisement that is related to the content of the user content item as compared to an advertisement that is unrelated to the content of the user content item.

Although various components of the data storage device 120 and/or the host device 110 of FIGS. 1, 2, 4, and 5 and the data storage device 920 and/or the access device 910 of FIGS. 9-11 depicted herein are illustrated as block components and described in general terms, such components may include one or more microprocessors, state machines, or other circuits configured to enable the various components to perform operations described herein. Components described herein may be operationally coupled to one another using one or more nodes, one or more buses (e.g., data buses and/or control buses), one or more other structures, or a combination thereof. One or more components described herein may include one or more physical components, such as hardware controllers, state machines, logic circuits, or other structures, or a combination thereof, to enable the data storage device 120 of FIGS. 1, 2, 4, and 5 and or data storage device 920 of FIGS. 9-11 to combine user content items with supplemental content items. One or more aspects of the various components may be implemented using a microprocessor or microcontroller programmed to perform operations described herein, such as one or more operations of the method 600 of FIG. 6, the method 700 of FIG. 7, the method 800 of FIG. 8, or the method 1200 of FIG. 12. In a particular implementation, each of the controller 124 and/or the host device 110 of FIGS. 1, 2, 4, and 5, or the controller 924 and/or the access device 910 of FIGS. 9-11 includes a processor executing instructions that are stored at a memory, such as a non-volatile memory of the data storage device 120 or the host device 110 of FIGS. 1, 2, 4, and 5 or a non-volatile memory of the data storage device 920 or the access device 910 of FIGS. 9-11. Alternatively or additionally, executable instructions that are executed by the processor may be stored at a separate memory location that is not part of the non-volatile memory, such as at a read-only memory (ROM) of the data storage device 120 or the host device 110 of FIGS. 1, 2, 4, and 5 or a ROM of the data storage device 920 or the access device 910 of FIGS. 9-11.

In conjunction with the described aspects, an apparatus includes means for storing one or more user content items, a plurality of supplemental content items, and a first plurality of keywords associated with the plurality of supplemental content items. For example, the means for storing may include the memory device 904, the first storage area 926, or the second storage area 928 of FIGS. 9-11, one or more other devices, circuits, or instructions to store user content items, supplemental content items, and keywords, or a combination thereof.

The apparatus includes means for analyzing content of a particular user content item of the one or more user content items to determine one or more descriptors related to the content. For example, the means for analyzing may include the controller 924 or the content analyzer 960 of FIGS. 9 and 10, one or more other devices, circuits, or instructions to analyze content of user content items, or a combination thereof.

The apparatus further includes means for combining the particular user content item with a particular supplemental content item of the plurality of supplemental content items to generate an augmented content item, where the particular supplemental content item is selected based on the one or more descriptors and the first plurality of keywords. For example, the means for combining may include the controller 924 or the selection unit 970 of FIGS. 9 and 10, one or more other devices, circuits, or instructions to combine user content items with supplemental content items to generate augmented content items, or a combination thereof. The particular user content item may include an image item, an audio file, a video file, a text document, or a video file.

In a particular implementation, the apparatus further includes means for ranking each descriptor of the one or more descriptors based on a number of occurrences of the descriptors in the particular user content item. For example, the means for ranking may include ranking engine 1074 of FIG. 10, the selection unit 970 or the controller 924 of FIGS. 9 and 10, one or more other devices, circuits, or instructions to rank descriptors based on numbers of occurrences, or a combination thereof.

In a particular embodiment, the data storage device 120 of FIGS. 1, 2, 4, and 5 or the data storage device 920 of FIGS. 9-11 may be a portable device configured to be selectively coupled to one or more external devices. However, in other embodiments, the data storage device 120 of FIGS. 1, 2, 4, and 5 or the data storage device 920 of FIGS. 9-11 may be attached or embedded within one or more host devices, such as within a housing of a portable communication device. For example, the data storage device 120 of FIGS. 1, 2, 4, and 5 or the data storage device 920 of FIGS. 9-11 may be within a packaged apparatus such as a wireless telephone, a personal digital assistant (PDA), gaming device or console, a portable navigation device, or other device that uses internal non-volatile memory. In a particular embodiment, the data storage device 120 includes a non-volatile memory, such as a flash memory (e.g., NAND, NOR, Multi-Level Cell (MLC), Divided bit-line NOR (DINOR), AND, high capacitive coupling ratio (HiCR), asymmetrical contactless transistor (ACT), or other flash memories), an erasable programmable read-only memory (EPROM), an electrically-erasable programmable read-only memory (EEPROM), a read-only memory (ROM), a one-time programmable memory (OTP), or any other type of memory.

The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Those of skill in the art will recognize that such modifications are within the scope of the present disclosure. Accordingly, the disclosure and the figures are to be regarded as illustrative rather than restrictive.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A data storage device comprising:
memory configured to store:
one or more user content items;
a plurality of supplemental content items; and
a first plurality of keywords associated with the plurality of supplemental content items; and
a controller coupled to the memory and configured to:
analyze content of a particular user content item of the one or more user content items to determine one or more descriptors related to the content;
select a particular supplemental content item of the plurality of supplemental content items based on the one or more descriptors and the first plurality of keywords; and
combine the particular supplemental content item with the particular user content item to generate an augmented content item.

2. The data storage device of claim 1, wherein:
the particular user content item comprises an image item, and
the controller is further configured to:
analyze the content of the image item to determine at least one object represented in the image item; and
determine the one or more descriptors based on the at least one object.

3. The data storage device of claim 1, wherein:
the particular user content item comprises a music file, and
the controller is further configured to:
analyze the content of the music file to determine at least one characteristic of the music file; and
determine the one or more descriptors based on the at least one characteristic.

4. The data storage device of claim 3, wherein:
the music file includes a song; and
the at least one characteristic corresponds to a name of the song.

5. The data storage device of claim 1, wherein:
the particular user content item comprises a speech file; and
the controller is further configured to:
analyze the content of the speech file by performing speech recognition to detect a plurality of words in the speech file; and
determine the one or more descriptors based on a comparison of the plurality of words and a second plurality of keywords stored in the memory.

6. The data storage device of claim 5, wherein:
the second plurality of keywords comprises a plurality of potential descriptors; and
the one or more descriptors are included in both the second plurality of keywords and the plurality of words.

7. The data storage device of claim 5, wherein the controller is further configured to rank each descriptor of the one or more descriptors based on ranking criteria.

8. The data storage device of claim 7, wherein:
the controller is further configured to determine a number of occurrences, in the speech file, of each descriptor of the one or more descriptors; and
the ranking criteria includes descriptor occurrence frequency.

9. The data storage device of claim 8, wherein the controller is further configured to:
generate a ranking table that ranks each descriptor of the one or more descriptors based on the number of occurrences of the descriptors in the speech file; and
perform a matching operation to match a prioritized descriptor to at least one keyword of the first plurality of keywords that is associated with the particular supplemental content item, the prioritized descriptor selected from the one or more descriptors based on the ranking table.

10. The data storage device of claim 1, wherein:
the particular user content item comprises a text document; and
the controller is further configured to:
analyze the content of the text document by performing word recognition to detect a plurality of words in the text document; and
determine the one or more descriptors based on a comparison of the plurality of words and a second plurality of keywords stored in the memory.

11. The data storage device of claim 10, wherein the controller is further configured to rank each descriptor of the one or more descriptors based on ranking criteria.

12. The data storage device of claim 11, wherein:
the controller is further configured to determine a number of occurrences, in the text document, of each descriptor of the one or more descriptors, and
the ranking criteria includes descriptor occurrence frequency.

13. The data storage device of claim 12, wherein the controller is further configured to:
generate a ranking table that ranks each descriptor of the one or more descriptors based on the number of occurrences of the descriptors in the text document; and
perform a matching operation to match a prioritized descriptor to at least one keyword of the first plurality of keywords that is associated with the particular supplemental content item, the prioritized descriptor selected from the one or more descriptors based on the ranking table.

14. A method comprising:
analyzing content of a particular user content item of one or more user content items stored at a memory to determine one or more descriptors related to the content;
selecting a particular supplemental content item of a plurality of supplemental content items stored at the memory based on the one or more descriptors and a plurality of keywords stored at the memory; and
combining the particular supplemental content item with the particular user content item to generate an augmented content item.

15. The method of claim 14, further comprising:
receiving a request for the particular user content item from an access device, wherein the augmented content item is generated in response to receiving the request; and
sending the augmented content item to the access device based on the request.

16. The method of claim 14, further comprising storing the augmented content item at the memory, wherein the augmented content item is generated during an idle time period or performance of a garbage collection operation.

17. The method of claim 14, further comprising updating the plurality of supplemental content items, the plurality of keywords, or both during an operational lifetime of the memory.

18. An apparatus comprising:
means for storing one or more user content items, a plurality of supplemental content items, and a plurality of keywords associated with the plurality of supplemental content items;
means for analyzing content of a particular user content item of the one or more user content items to determine one or more descriptors related to the content; and
means for combining the particular user content item with a particular supplemental content item of the plurality of supplemental content items to generate an augmented content item, wherein the particular supplemental content item is selected based on the one or more descriptors and the plurality of keywords.

19. The apparatus of claim 18, further comprising means for ranking each descriptor of the one or more descriptors based on a number of occurrences of the descriptors in the particular user content item, wherein a prioritized descriptor of the one or more descriptors matches a keyword of the plurality of keywords that is associated with the particular supplemental content item.

20. The apparatus of claim 18, wherein the particular user content item comprises an image item, an audio file, a video file, a text document, or a video file.
